(19) United States
(12) Patent Application Publication
(10) Pub. No.: US 2025/0390125 A1
(43) Pub. Date: Dec. 25, 2025

(54) ELECTRONIC DEVICE FOR ADJUSTING VOLTAGES OF REGULATING CIRCUITS ON BASIS OF STATE OF COMPONENT CORRESPONDING TO REGULATING CIRCUITS AND METHOD THEREOF

(71) Applicant: SAMSUNG ELECTRONICS CO., LTD., Suwon-si (KR)

(72) Inventors: Jooyeol RYU, Suwon-si (KR); Byoungjun KIM, Suwon-si (KR); Sunglak KIM, Suwon-si (KR); Hyunmuk KIM, Suwon-si (KR); Shinhyuk YOON, Suwon-si (KR); Gyudae JANG, Suwon-si (KR); Jaeyoung JUN, Suwon-si (KR); Jinwook CHOI, Suwon-si (KR)

(21) Appl. No.: 19/315,671

(22) Filed: Sep. 1, 2025

Related U.S. Application Data
(63) Continuation of application No. PCT/KR2024/003890, filed on Mar. 27, 2024.

(30) Foreign Application Priority Data
May 15, 2023 (KR) 10-2023-0062708
May 30, 2023 (KR) 10-2023-0069586

(51) Int. Cl. G05F 1/46; G05F 1/565; G05F 1/66; G06F 1/28

(52) U.S. Cl. CPC G05F 1/462; G05F 1/565; G05F 1/66; G06F 1/28

(57) ABSTRACT

A processor of an electronic device identifies an event for regulating the driving state of a component connected to one of a plurality of regulating circuits. The processor controls a power management integrated circuit (PMIC) to increase the voltage of a power signal in response to the current for driving the component increasing due to the event. The processor controls the PMIC to decrease the voltage of the power signal in response to the current for driving the component decreasing due to the event.

### CROSS-REFERENCE TO RELATED APPLICATIONS

This application is a continuation of International Application No. PCT/KR2024/003890 designating the United States, filed on Mar. 27, 2024, in the Korean Intellectual Property Receiving Office and claiming priority to Korean Patent Application Nos. 10-2023-0062708, filed on May 15, 2023, and 10-2023-0069586, filed on May 30, 2023, in the Korean Intellectual Property Office, the disclosures of each of which are incorporated by reference herein in their entireties.

### BACKGROUND

### (1) Field

The present disclosure relate to an electronic device for adjusting a voltage of a regulating circuit based on a state of a component corresponding to the regulating circuit and a method thereof.

### (2) Description of the Related Art

An electronic device such as a smartphone, a tablet personal computer (PC), or a smart watch may include various components to provide enhanced convenience. For an operation of the components, a power circuit in the electronic device may be designed to provide voltages suitable for each of the components to the components in the electronic device.

### SUMMARY

An electronic device according to an embodiment includes a power management integrated circuit (PMIC), a plurality of regulating circuits which receives a power signal of the PMIC, memory including one or more storage media storing instructions, and at least one processor including processing circuitry. In such an embodiment, the instructions, when executed by the at least one processor individually and/or collectively, causes the electronic device to identify an event for adjusting a driving state of a component connected to one of the plurality of regulating circuits. In such an embodiment, the instructions, when executed by the at least one processor individually and/or collectively, causes the electronic device to, in response to identifying that a current for driving the component is increased by the event, control the PMIC to increase a voltage of the power signal. In such an embodiment, the instructions, when executed by the at least one processor individually and/or collectively, causes the electronic device to, in response to identifying that a current for driving the component is decreased by the event, control the PMIC to decrease the voltage of the power signal.

A method of an electronic device according to an embodiment includes identifying an event for adjusting a driving state of a component connected to one of a plurality of regulating circuits of the electronic device which receives a power signal of a PMIC of the electronic device. In such an embodiment, the method includes, in response to identifying that a current for driving the component is increased by the event, controlling the PMIC to increase a voltage of the power signal. In such an embodiment, the method includes, in response to identifying that a current for driving the component is decreased by the event, controlling the PMIC to decrease the voltage of the power signal.

An electronic device according to an embodiment includes a power management integrated circuit (PMIC), a plurality of regulating circuits which receives a power signal from the PMIC through a signal path extended from the PMIC, and a processor. In such an embodiment, the processor is configured to identify, based on an event for adjusting a state of a component connected to a first regulating circuit among the plurality of regulating circuits, a first input current and a first input voltage of the first regulating circuit modified by the component switched to be in the state. In such an embodiment, the processor is configured to identify a maximum voltage from the first input voltage and second input voltages of, among the plurality of regulating circuits, enabled second regulating circuits different from the first regulating circuit. In such an embodiment, the processor is configured to control the PMIC, to adjust a voltage of the power signal in response to the event, based on the maximum voltage, the first input current, second input currents of the second regulating circuits and a path resistance of the signal path.

A method of an electronic device according to an embodiment includes identifying, based on an event for adjusting a state of a component connected to a first regulating circuit among a plurality of regulating circuits of the electronic device, a first input current and a first input voltage of the first regulating circuit modified by the component switched be in to the state. In such an embodiment, the plurality of regulating circuits receives a power signal from a power management integrated circuit (PMIC) through a signal path extended from the PMIC of the electronic device, and a processor. In such an embodiment, the method includes identifying a maximum voltage from the first input voltage and second input voltages of, among the plurality of regulating circuits, enabled second regulating circuits different from the first regulating circuit. In such an embodiment, the method includes controlling the PMIC, to adjust a voltage of the power signal in response to the event, based on the maximum voltage, the first input current, second input currents of the second regulating circuits and a path resistance of the signal path.

### BRIEF DESCRIPTION OF THE DRAWINGS

FIG. 1 illustrates an example of a block diagram of an electronic device according to an embodiment.

FIG. 2 illustrates an example of a flowchart of an electronic device according to an embodiment.

FIG. 3 illustrates an example of a block diagram of an electronic device according to an embodiment.

FIGS. 4A to 4B illustrate an example of a flowchart of an operation of an electronic device for controlling an LDO regulating circuit.

FIG. 5 illustrates an example of a graph for describing adjustment of voltages in an electronic device, according to an embodiment.

FIGS. 6A to 6B illustrate an example of a flowchart of an operation of an electronic device for controlling an LDO regulating circuit.

FIG. 7 illustrates an example of a graph for describing adjustment of voltages in an electronic device, according to an embodiment.

FIG. 8 illustrates an example of a flowchart of an operation of an electronic device for controlling a PMIC based on a state of a component.

FIG. 9 illustrates an example of a block diagram of an electronic device according to an embodiment.

FIG. 10 illustrates an example of a flowchart of an operation of an electronic device for controlling a PMIC based on a state of a component.

FIG. 11 is a block diagram of an electronic device in a network environment according to various embodiments.

FIG. 12 is a block diagram of a power management module and a battery according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The various embodiments of the present document and terms used herein are not intended to limit the technology described in the present document to specific embodiments, and should be understood to include various modifications, equivalents, or substitutes of the corresponding embodiment.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. In the present document, an expression such as “A or B”, “at least one of A and/or B”, “at least one selected from A and/or B”, “A, B or C”, or “at least one of A, B and/or C”, “at least one selected from A, B and/or C”, and the like may include all possible combinations of items listed together. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be understood that when an element is referred to as being “on” another element, it can be directly on the other element or intervening elements may be present therebetween. In contrast, when an element is referred to as being “directly on” another element, there are no intervening elements present. When a (e.g., first) component is referred to as “connected (functionally or communicatively)” or “accessed” to another (e.g., second) component, the component may be directly connected to the other component or may be connected through another component (e.g., a third component).

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

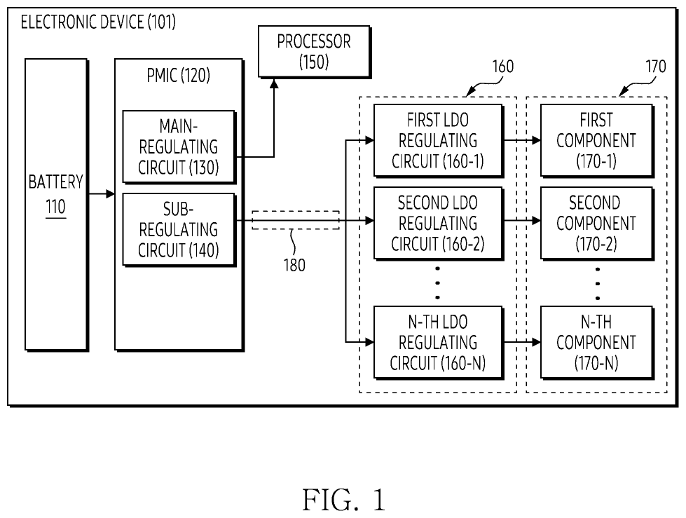

FIG. 1 illustrates an example of a block diagram of an electronic device 101 according to an embodiment. The electronic device 101 of FIG. 1 may include a terminal (e.g., a mobile phone) that is owned or to be used by a user. The electronic device 101 according to an embodiment may operate based on electrical energy stored in (or power supplied from) a battery 110. Referring to FIG. 1, a circuit of the electronic device 101 driven by the electrical energy may be distinguished into different blocks based on a function and/or an operation. The electronic device 101 according to an embodiment may include at least one selected from the battery 110, a power management integrated circuit (PMIC) 120, a processor 150, a plurality of low drop-out (LDO) regulating circuits 160, or a plurality of components 170. Hereinafter, a component (or a load circuit) of the electronic device 101 may include hardware and/or circuitry that operates by a power signal provided from at least one of the plurality of LDO regulating circuits 160. For example, the component may include hardware and/or a circuit in the electronic device 101 different from the processor 150. An embodiment is not limited thereto, and the component may include circuitry in the processor 150 that operates by the power signal provided from the LDO regulating circuit.

The battery 110 of the electronic device 101 according to an embodiment may output electrical energy for driving other circuitry and/or hardware in the electronic device 101 from chemical energy. For example, the battery 110 of the electronic device 101 may include a battery cell, a battery module, or a battery pack. The battery 110 may include a capacitor or a secondary battery that stores power by charging. In terms of supporting recharging, the battery 110 may be referred to as a rechargeable battery. For example, the battery 110 may be any one of a lithium ion (Li-ion) battery, a lithium ion polymer (Li-ion polymer) battery, a lead storage battery, a nickel-cadmium (NiCd) battery, and a nickel hydrogen storage (NiMH) battery. The battery 110 of the electronic device 101 may be charged, for example, by power received from at least a portion of the PMIC 120. When magnitude of a current inputted to the battery 110 is greater than magnitude of a current outputted from the battery 110, the battery 110 may be charged. When the magnitude of the current outputted from the battery 110 is greater than the magnitude of the current inputted to the battery 110, the battery 110 may be discharged.

The PMIC 120 of the electronic device 101 according to an embodiment may be configured to provide the power obtained from the battery 110 to each of hardware (e.g., the processor 150, the plurality of LDO regulating circuits 160, and/or the plurality of components 170) in the electronic device 101. Power signals provided from the PMIC 120 to each of the hardware may be controlled by the processor 150. The power signal provided from the PMIC 120 may be an electrical signal having a direct current (DC) voltage required (or desired to be used) to drive the processor 150 and/or the component corresponding to the power signal.

In drawings including FIG. 1, an operation in which the electrical energy stored in the battery 110 is transferred to the hardware in the electronic device 101 through the PMIC 120 is described, but an embodiment is not limited thereto. In an embodiment, the PMIC 120 may include an interface for receiving power from an external power source. For example, the interface may include a port (e.g., a USB-C type port) for receiving electrical energy from a distribution system such as a concentric plug. For example, the interface may include an antenna (e.g., a coil-based antenna) for wirelessly receiving electrical energy based on an electric field and/or a magnetic field. The electrical energy received through the interface may be transmitted from the PMIC 120 to the battery 110 and stored in the battery 110.

The PMIC 120 of the electronic device 101 according to an embodiment may include a plurality of regulating circuits for generating power signals having a voltage suitable or desirable for each of the hardware in the electronic device 101. Referring to FIG. 1, the plurality of regulating circuits in the PMIC 120 are illustrated by being divided into a main-regulating circuit 130 and a sub-regulating circuit 140 based on whether a power signal to be transmitted to the processor 150 of the electronic device 101 is generated. For example, the main-regulating circuit 130 may generate and/or output a power signal having a voltage for driving the processor 150 from a power signal provided from the battery 110. For example, the sub-regulating circuit 140 may generate and/or output a power signal for driving the components 170 of the electronic device 101 different from the processor 150 from the power signal provided from the battery 110. Referring to FIG. 1, a type and/or the number of the plurality of regulating circuits included in PMIC 120 is not limited to the main-regulating circuit 130 and the sub-regulating circuit 140 of FIG. 1. The main-regulating circuit 130 and/or the sub-regulating circuit 140 may include a buck converter, a booster converter, or a combination thereof. An embodiment is not limited thereto, and a DC-DC converter for converting a DC voltage may be included in the main-regulating circuit 130 and/or the sub-regulating circuit 140.

The processor 150 of the electronic device 101 according to an embodiment may include hardware (or processing circuitry or circuitry) for processing data based on one or more instructions. The hardware for processing the data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). The number of the processors 150 may be one or greater. For example, the processor 150 may have a structure of a multi-core processor such as a dual core, a quad core, or a hexa core. The processor 150 may operate based on a power signal provided from the main-regulating circuit 130. In a case where the processor 150 includes circuits driven at different DC voltages, the PMIC 120 may further include a regulating circuit for providing power signals having the different DC voltages to the processor 150 as well as the main-regulating circuit 130.

The processor 150 of the electronic device 101 according to an embodiment may execute a function for increasing a power efficiency of the electronic device 101 while the hardware of the electronic device 101 including the processor 150 is at least partially activated using the battery 110. The power efficiency of the electronic device 101 may mean a ratio of electrical energy substantially used for driving the electronic device 101 among electrical energy inputted to the electronic device 101. For example, the processor 150 may modify a voltage of the power signal transmitted from the main-regulating circuit 130 to the processor 150 based on a driving frequency of the processor 150. In order to modify the voltage of the power signal transmitted from the main-regulating circuit 130 to the processor 150, the processor 150 may control the PMIC 120. For example, the voltage of the power signal may be modified by the PMIC 120 controlled by the processor 150 to improve the power efficiency of the electronic device 101.

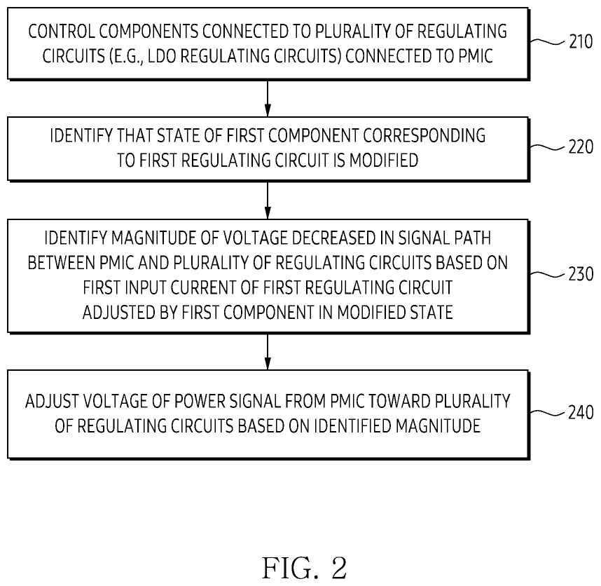

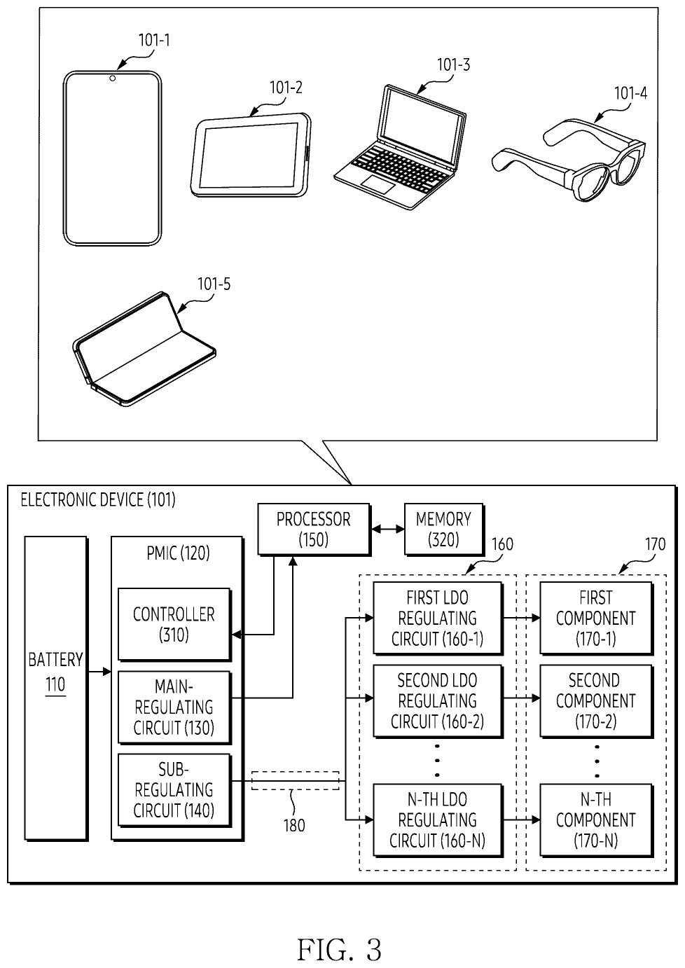

In an embodiment, the processor 150 may control the sub-regulating circuit 140 of the PMIC 120 to adaptively improve a power efficiency of a load circuit (e.g., the LDO regulating circuits 160 and/or the components 170) connected to the sub-regulating circuit 140 and the sub-regulating circuit 140. In order to improve the power efficiency, the processor 150 may transmit a control signal for adjusting a voltage of a power signal outputted from the sub-regulating circuit 140 to the PMIC 120. By optimizing the power efficiency associated with the sub-regulating circuit 140, the processor 150 may efficiently utilize the electrical energy stored in the battery 110. As the power efficiency increases, a life of the battery 110 may increase. An operation of controlling the PMIC 120 by the processor 150 to improve the power efficiency associated with the sub-regulating circuit 140 will be described with reference to FIGS. 2, 4A, 4B, 6A, 6B, 8, and/or 10. An example structure of an embodiment of the PMIC 120 for processing the control signal transmitted from the processor 150 will be described with reference to FIG. 3.

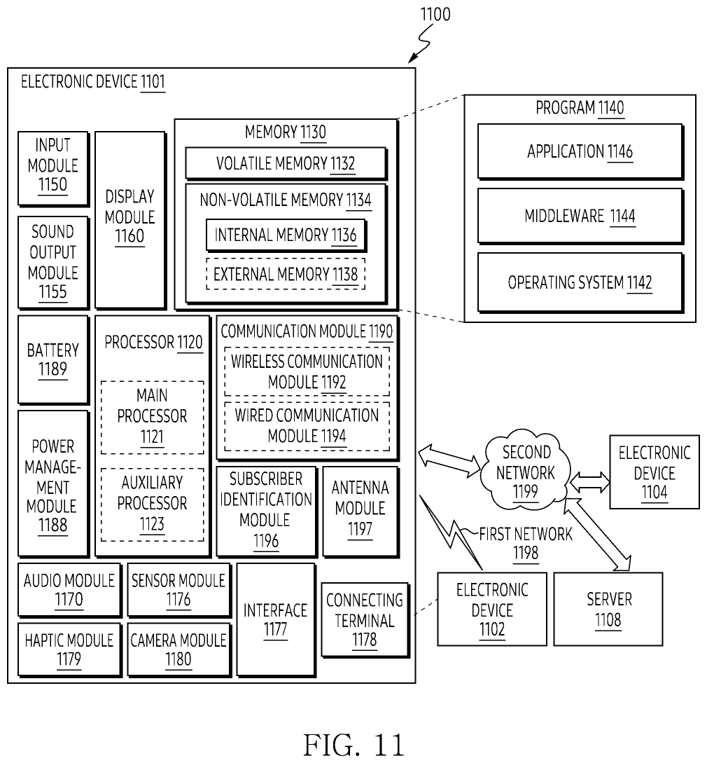

The processor 150 of the electronic device 101 according to an embodiment may execute various functions by controlling the components 170. The components 170 included in the electronic device 101 may include a camera, a digitizer, a display, communication circuitry, a sensor (e.g., a grip sensor, a global positioning system (GPS) sensor, and/or an inertial measurement unit (IMU)), a speaker, and/or a microphone. An example of the components 170 included in the electronic device 101 will be described with reference to FIG. 11.

In an embodiment, currents (e.g., an input current) and/or voltages (e.g., an input voltage) inputted to the components 170 may be different from each other. Referring to FIG. 1, the electronic device 101 according to an embodiment may include the LDO regulating circuits 160 connected to each of the components 170 and configured to provide an input voltage required to drive a component. The LDO regulating circuit may include a linear regulating circuit based on transistors. Among DC-DC regulating circuits based on a DC voltage, a difference (or a ratio) between an input voltage and an output voltage of the LDO regulating circuit may be smaller than another regulating circuit different from the LDO regulating circuit. The LDO regulating circuit may generate and/or output a power signal having an output voltage less than an input voltage of a power signal inputted to the LDO regulating circuit.

In an embodiment, the LDO regulating circuit does not include an inductor, unlike the buck converter (e.g., the sub-regulating circuit 140) including the inductor. The LDO regulating circuit not including the inductor may have a volume smaller than that of the sub-regulating circuit 140 including the buck converter. The LDO regulating circuit having the volume smaller than that of the sub-regulating circuit 140 may generate a power signal having a specific input voltage by being connected to one component requiring (or desired to use) the specific input voltage. As illustrated in an embodiment of the electronic device 101 of FIG. 1, the plurality of LDO regulating circuits 160 and the plurality of components 170 may be connected to each other with a one-to-one correspondence. For example, among the N LDO regulating circuits 160, a first LDO regulating circuit 160-1 may be connected to a first component 160-1 among the N components 170. Here, N is a natural number greater than 1. A second LDO regulating circuit 160-2 may be connected to a second component 160-2 and generate a power signal of a voltage required (or desired) to drive the second component 160-2. An N-th LDO regulating circuit 160-N connected to an N-th component 170-N may generate a power signal for driving the N-th component 170-N from a power signal provided from the sub-regulating circuit 140. An embodiment is not limited thereto.

Referring to FIG. 1, an example structure of an embodiment of the electronic device 101 including the plurality of LDO regulating circuits 160 connected to the sub-regulating circuit 140 of the PMIC 120 through a signal path 180 is illustrated. The signal path 180 may be formed on a printed circuit board (PCB) on which the PMIC 120 and the plurality of LDO regulating circuits 160 are disposed or a flexible PCB (FPCB) connecting the PMIC 120 and the plurality of regulating circuits 160. For example, a group of the LDO regulating circuits 160 spaced apart from the PMIC 120 through the signal path 180 may be referred to as a PMIC. By a resistance of the signal path 180, a voltage (e.g., an input voltage for the plurality of LDO regulating circuits 160) of a power signal transmitted from the sub-regulating circuit 140 to the plurality of LDO regulating circuits 160 may be attenuated.

In an embodiment, the resistance of the signal path 180 between the sub-regulating circuit 140 and the LDO regulating circuits 160 may be referred to as a path resistance. Based on Ohm's law, magnitude of the voltage of the power signal decreased or attenuated while being transmitted in the signal path 180 may correspond to a multiplication of a current of the power signal and the path resistance. Hereinafter, the magnitude of the voltage of the power signal decreased or attenuated while being transmitted in the signal path 180 may be referred to as a voltage drop of the signal path 180.

In an embodiment, a power efficiency of the LDO regulating circuit may be associated with a ratio between the input voltage and the output voltage of the LDO regulating circuit. For example, as a difference between the input voltage and the output voltage decreases (or as the ratio of the output voltage to the input voltage increases), the power efficiency of the LDO regulating circuit may be improved. An output current of the LDO regulating circuit may be associated with the difference between the input voltage and the output voltage of the LDO regulating circuit. For example, in a case where the input voltage is fixed, as the output current of the LDO regulating circuit increases, the output voltage of the LDO regulating circuit may decrease. Hereinafter, a voltage drop of the LDO regulating circuit may correspond to the difference between the input voltage and the output voltage of the LDO regulating circuit.

Referring to FIG. 1, the input voltage of the plurality of LDO regulating circuits 160 connected to the sub-regulating circuit 140 of the PMIC 120 through the signal path 180 may correspond to an output voltage of the sub-regulating circuit 140 from which the voltage drop of the signal path 180 is subtracted. Since output voltages of the plurality of LDO regulating circuits 160 are set differently for driving the components 170, the power efficiencies of the plurality of LDO regulating circuits 160 may be different from each other. The processor 150 of the electronic device 101 according to an embodiment may control the sub-regulating circuit 140 and/or the PMIC 120 to improve the power efficiencies. The input voltage of the plurality of LDO regulating circuits 160 may be adjusted by the sub-regulating circuit 140 controlled by the processor 150.

In an embodiment, the processor 150 may individually modify a state of the components 170. For example, the processor 150 of the electronic device 101 corresponding to a smartphone may activate the speaker and/or the microphone among the components 170 while a phone call function is executed, and may deactivate the speaker and/or the microphone based on a completion (or a termination or a cessation) of the phone call function. In this case, input currents of the speaker and/or the microphone may increase or decrease according to execution of the phone call function. For example, an input current of the display among the components 170 may be modified according to brightness of pixels included in the display. In an embodiment, the state of the components 170 may be adjusted by the processor 150 identifying an event generated by a user input (e.g., a user input to execute the phone call function), an electrical signal (e.g., a wireless signal to notify an incoming call), and/or a software application (e.g., an alarm application that outputs an alarm based on a registered timing).

The processor 150 of the electronic device 101 according to an embodiment may identify an event for adjusting a state of at least one of the plurality of components 170. The processor 150 may calculate, identify, or predict input voltages and/or input currents of the components 170 after the state of at least one of the components 170 is modified by the event. Based on the input voltages and/or the input currents, the processor 150 may modify the output voltage (e.g., a voltage of a power signal transmitted to the plurality of LDO regulating circuits 160) of the sub-regulating circuit 140. The output voltage may correspond to a sum of a maximum input voltage among the input voltages and a voltage drop of a LDO regulating circuit generating the maximum input voltage and the voltage drop of the signal path 180. An embodiment is not limited thereto, and the processor 150 may adjust the output voltage of the sub-regulating circuit 140 in a range greater than or equal to the sum. For example, the range greater than or equal to the sum may have a value obtained by adding a preset offset voltage or a preset margin voltage from the sum as a lower limit.

As described above, the processor 150 of the electronic device 101 according to an embodiment may identify an event for adjusting a state of a component connected to any one of the plurality of LDO regulating circuits 160. For example, in a case where a current for driving an event-related component is increased based on the state controlled by the event, the processor 150 may control the PMIC 120 to increase a voltage of a power signal according to the path resistance of the signal path 180 and the current to be increased by the event. For example, in a case where the current for driving the event-related component is decreased based on the state controlled by the event, the processor 150 may control the PMIC 120 to reduce the voltage of the power signal according to the path resistance of the signal path 180 and the current to be decreased by the event. By adaptively adjusting the voltage of the power signal (e.g., the power signal outputted from the sub-regulating circuit 140) outputted from the PMIC 120 based on a state of the component, the processor 150 may improve a power efficiency of a LDO regulating circuit corresponding to the component.

Hereinafter, an operation of the electronic device 101 and/or the processor 150 for improving a power efficiency of the plurality of LDO regulating circuits 160 will be described with reference to FIG. 2.

FIG. 2 illustrates an example of a flowchart of an electronic device according to an embodiment. The electronic device 101 and/or the processor 150 of FIG. 1 may perform operations described with reference to FIG. 2.

Referring to FIG. 2, in operation 210, a processor of the electronic device according to an embodiment may control components (e.g., the components 170 of FIG. 1) connected to a plurality of regulating circuits (e.g., the plurality of LDO regulating circuits 160 of FIG. 1) connected to a PMIC (e.g., the PMIC 120 of FIG. 1). The plurality of regulating circuits of the operation 210 may be electrically connected to a sub-regulating circuit (e.g., the sub-regulating circuit 140 of FIG. 1) of the PMIC. The components included in the electronic device may operate under different driving conditions (e.g., an input voltage). Among the components included in the electronic device, components driven in a similar input voltage may be electrically connected to one regulating circuit or a same regulating circuit (e.g., the sub-regulating circuit 140 of FIG. 1 of the PMIC. In an embodiment, an additional regulating circuit (e.g., the LDO regulating circuits 160 of FIG. 1) may be positioned between the components and the sub-regulating circuit to generate an input voltage required to drive the components from a power signal provided from the sub-regulating circuit of the PMIC.

In an embodiment, the processor controlling the components based on the operation 210 may include an operation of modifying a state of at least one of the components. Based on execution of one or more instructions, the processor may modify the state of the at least one of the components. Based on a user input for controlling a component, the processor may perform the operation 210. For example, the user input may be received or identified through a user interface (UI) displayed through a display of the electronic device. An embodiment is not limited thereto, and the processor may perform the operation 210 based on a software interrupt (SWI) identified by at least one of components distinguished from the processor, a software application, or a user input.

In an embodiment, the state of the component may include an inactive state in which a voltage and/or a current of substantially zero is received, and an active state different from the inactive state. For example, the active state may include an idle state in which the component receives a minimum voltage and/or a minimum current for driving thereof. For example, the active state, which is a state referred to as a saturation state, may include a state in which an input current of the component is maximized. The input voltage and/or the input current of the component may be dependent on the state of the component controlled by the operation 210.

Referring to FIG. 2, in operation 220, the processor of the electronic device according to an embodiment may identify that a state of a first component corresponding to a first regulating circuit is modified or changed. The first regulating circuit of the operation 220 may be configured to provide the first component with a power signal having a voltage required (or to be used) to drive the first component, such as the LDO regulating circuits 160 of FIG. 1. For example, based on an LDO, the first regulating circuit may obtain a power signal of a second voltage, which is required to drive the first component from a power signal of a first voltage and is less than the first voltage. The processor may identify an event for modifying the state of the first component based on the operation 220. The processor identifying the modification of the state of the first component may perform the operation 230.

Referring to FIG. 2, in operation 230, the processor of the electronic device according to an embodiment may identify magnitude of a voltage decreased in a signal path between the PMIC and the plurality of regulating circuits based on a first input current of the first regulating circuit controlled by the first component in the modified state. The PMIC of the operation 230 may include the PMIC 120 of FIG. 1. The signal path of the operation 230 may include the signal path 180 of FIG. 1. The magnitude of the voltage of the operation 230 may be associated with a voltage drop of the signal path. In an embodiment, the operation 230 may be performed before the state of the component is modified or changed to the state identified based on the operation 220.

In an embodiment, the processor may identify a voltage drop of the signal path based on a path resistance of the signal path and the first input current of the operation 230. The processor may identify a sum of input currents of the first input corresponding to the first regulating circuit and other regulating circuits receiving a power signal through the signal path. For example, the processor may calculate the voltage drop in the signal path by multiplying the identified sum by the path resistance.

In an embodiment, the processor identifying the event for modifying (or changing) the state of the first component may identify a current to be used to drive the first component and an input voltage of the first regulating circuit corresponding to the current based on the state of the first component corresponding to the event. The input voltage of the first regulating circuit may correspond to a combination of the voltage required (or desired or to be used) to drive the first component and a voltage drop of the first regulating circuit corresponding to the current.

Referring to FIG. 2, in operation 240, the processor of the electronic device according to an embodiment may adjust a voltage of a power signal from the PMIC toward the plurality of regulating circuits based on the identified magnitude. For example, the processor may adjust the voltage of the power signal by V_{sub-regulator} of Equation 1 by controlling the PMIC.

$${V}_{sub - regulator} = {I}_{SUM} \times R + {V}_{MAX - LDO} \qquad [ Equation 1 ]$$

Referring to Equation 1, I_{SUM} denotes a sum of the first input current in the operation 230 and input currents of other regulating circuits different from the first regulating circuit among regulating circuits connected to the PMIC. R of Equation 1 denotes a path resistance. V_{MAX-LDO} of Equation 1 denotes a maximum value of input voltages required to drive the regulating circuits connected to the PMIC. For example, V_{MAX-LDO} may correspond to a maximum value among the input voltage required (or desired) by the first regulating circuit to provide the first component with the first input current of the operation 230 and input voltages of the other regulating circuits different from the first regulating circuit. V_{MAX-LDO} may be identified among input voltages of activated regulating circuits among the regulating circuits of the operation 210 after the state of the first component is modified. Referring to Equation 1, as a voltage of a power signal outputted from the PMIC is maintained as V_{sub-regulator} exceeding V_{MAX-LDO}, the processor may not deactivate the activated regulating circuits among the regulating circuits of the operation 210.

As described above, in a case where the input current of the component is adjusted by a modification (or change) of a state of the component, the processor of the electronic device according to an embodiment may modify the voltage of the power signal outputted from the PMIC to drive the component based on the adjusted input current. In a case where the input current of the component is modified, a current (e.g., I_{SUM} of Equation 1) of the power signal may be modified. As the current of the power signal is modified, a voltage drop generated in a signal path (e.g., the signal path 180 of FIG. 1) between the PMIC and the components may be modified. Based on the modified voltage drop, the processor may modify the voltage of the power signal. As the voltage of the power signal is modified, the processor may improve a power efficiency of the regulating circuits (e.g., the LDO regulating circuits) of the operation 210 of receiving the power signal. For example, the processor may adaptively modify the voltage of the power signal by modifying the voltage of the power signal based on Equation 1 whenever the state of the component is modified. Based on the improvement of the power efficiency, the processor may reduce a consumption current of the entire electronic device 101 and reduce a heat generation of the electronic device 101.

Hereinafter, an example of an operation in which the processor that adjusts the voltage of the power signal based on the operation 240 of FIG. 2 controls the PMIC will be described with reference to FIG. 3.

FIG. 3 illustrates an example of a block diagram of an electronic device 101 according to an embodiment. The electronic device 101 according to an embodiment may have a mobile form factor including a battery 110. Referring to FIG. 3, the electronic device 101 may have a form factor (e.g., a shape, a size, or a physical property) of a smartphone 101-1, a smartpad, and/or a tablet personal computer (PC) 101-2. The electronic device 101 may have a form factor of a personal computer (PC) including a laptop computer 101-3 and/or a desktop computer. The electronic device 101 may have a form factor of a smart accessory such as a smartwatch and/or a head-mounted device (HMD) 101-4. The electronic device 101 may have a form factor of a deformable device (e.g., a mobile phone 101-5 including a flexible display that is foldable by one or more axes).

A processor 150 of the electronic device 101 according to an embodiment may control a PMIC 120 to improve a power efficiency or increase a time that is drivable by the battery 110. Referring to FIG. 3, the PMIC 120 of the electronic device 101 according to an embodiment may include a controller 310 for controlling a main-regulating circuit 130 and/or a sub-regulating circuit 140. The controller 310 and/or the PMIC 120 may be connected to the processor 150 based on a serial interface. The serial interface connecting the processor 150 and the PMIC 120 (or the controller 310) may include, for example, a system power management interface (SPMI), inter-integrated circuit (I2C) communication, a serial peripheral interface (SPI), and/or a mobile industry processor interface (MIPI).

The processor 150 according to an embodiment may modify (or adjust) a voltage of a power signal transmitted from the sub-regulating circuit 140 to a plurality of LDO regulating circuits 160 by performing the operation of FIG. 2. For example, the processor 150 may transmit a control signal to the controller 310 of the PMIC 120 and/or the PMIC 120 to increase or reduce the voltage of the power signal. For example, the control signal may be transmitted based on the SPMI. The control signal may include a command and/or data for storing a parameter in a register of the controller 310 and/or the PMIC 120. For example, the data included in the control signal may include V_{sub-regulator} of Equation 1. The controller 310 may adjust an output voltage of the sub-regulating circuit 140 based on the parameter inputted to the register.

Referring to FIG. 3, the electronic device 101 according to an embodiment may include memory 320. The memory 320 may include hardware for storing data and/or an instruction inputted to the processor 150 and/or outputted from the processor 150. The memory 320 may include, for example, volatile memory such as random-access memory (RAM) and/or non-volatile memory such as read-only memory (ROM). The volatile memory may include, for example, at least one selected from dynamic RAM (DRAM), static RAM (SRAM), cache RAM, and pseudo SRAM (PSRAM). The non-volatile memory may include, for example, at least one selected from programmable ROM (PROM), erasable PROM (EPROM), electrically erasable PROM (EEPROM), flash memory, a hard disk, a compact disk, a solid state drive (SSD), or an embedded multi media card (eMMC).

The processor 150 of the electronic device 101 according to an embodiment may identify input voltages and/or input currents of components 170 based on profile information stored in the memory 320. For example, an input voltage required to drive a component, states (e.g., an idle state and/or a saturation state) of the component, and pairs of input currents of the component in each of the states may be stored in the profile information of the memory 320. The profile information may include data on a voltage drop of an LDO regulating circuit corresponding to the component. For example, the profile information may include a pair of the input current of the component and the voltage drop generated in the LDO regulating circuit that provides the input current. In a case where the input current of the component varies based on the state of the component, the profile information may indicate a relationship between the state of the component, the input current of the component, and the voltage drop of the LDO regulating circuit.

Referring to FIG. 3, the plurality of LDO regulating circuits 160 may be connected to receive the power signal from the sub-regulating circuit 140 through a signal path 180 extending from the sub-regulating circuit 140 of the PMIC 120. Although an embodiment where the PMIC 120 includes a single sub-regulating circuit 140 is illustrated in FIG. 3 as an example, an embodiment is not limited thereto. The electronic device 101 may include one or more sub-regulating circuits.

The processor 150 of the electronic device 101 according to an embodiment may individually adjust states of the components 170. For example, based on an event for adjusting a state of a first component 170-1 connected to a first LDO regulating circuit 160-1, the processor 150 may identify a first input voltage and a first input current of the first LDO regulating circuit 160-1, which are modified by the first component 170-1 switched to be in the state. The processor 150 may identify the first input voltage and the first input current from profile information stored in the memory 320 and corresponding to the first component 170-1. For example, the profile information corresponding to the first component 170-1 may be provided from a vendor of the first component 170-1. Based on the profile information corresponding to the first component 170-1, the processor 150 may identify the state of the first component 170-1 and a combination of the first input voltage and the first input current. Based on the combination, the processor may identify the first input voltage and the first input current. The first input voltage and/or the first input current may be different from an input voltage and/or an input current of the first component 170-1 before the event. For example, the event may cause a change in the input voltage and/or the input current of the first component 170-1.

In an embodiment, the processor 150 may identify second input voltages of activated LDO regulating circuits from other LDO regulating circuits (e.g., a second LDO regulating circuit 160-2 to an N-th LDO regulating circuit 160-N) different from the first LDO regulating circuit 160-1. The processor may identify second input currents of the activated LDO regulating circuits. The processor 150 may identify the second input voltages and/or the second input currents from profile information stored in the memory 320 and corresponding to each of the activated LDO regulating circuits.

In an embodiment, the processor 150 may identify a maximum voltage among the first input voltage and the second input voltages. The maximum voltage identified by the processor 150 may be matched to V_{MAX-LDO} of Equation 1. The processor 150 may control the PMIC 120 and/or the controller 310, to adjust the voltage of the power signal of the sub-regulating circuit 140 in response to the event, based on the maximum voltage, the first input current, the second input currents, and a path resistance of the signal path 180. The path resistance (e.g., R of Equation 1) of the signal path 180 may be identified by a file and/or the profile information stored in the memory 320. The first input current and the second input current may be used to obtain I_{SUM} of Equation 1. For example, the processor may transmit a control signal for adjusting the output voltage of the sub-regulating circuit 140 to a combination of the maximum voltage and a voltage drop of the signal path 180 based on the path resistance to the PMIC 120 and/or the controller 310. The controller 310 may adjust the output voltage of the sub-regulating circuit 140 based on the control signal.

Referring to FIG. 3, an operation in which the controller 310 controls the sub-regulating circuit 140 based on the control signal of the processor 150 is described, but an embodiment is not limited thereto. In an embodiment, the controller 310 may adaptively adjust the output voltage of the sub-regulating circuit 140 by performing the operation described with reference to FIG. 2 before receiving the control signal of the processor 150 (or without the control signal). The controller 310 may calculate and/or adjust the output voltage of the sub-regulating circuit 140 based on the states of the components 170 identified by communicating with the processor 150.

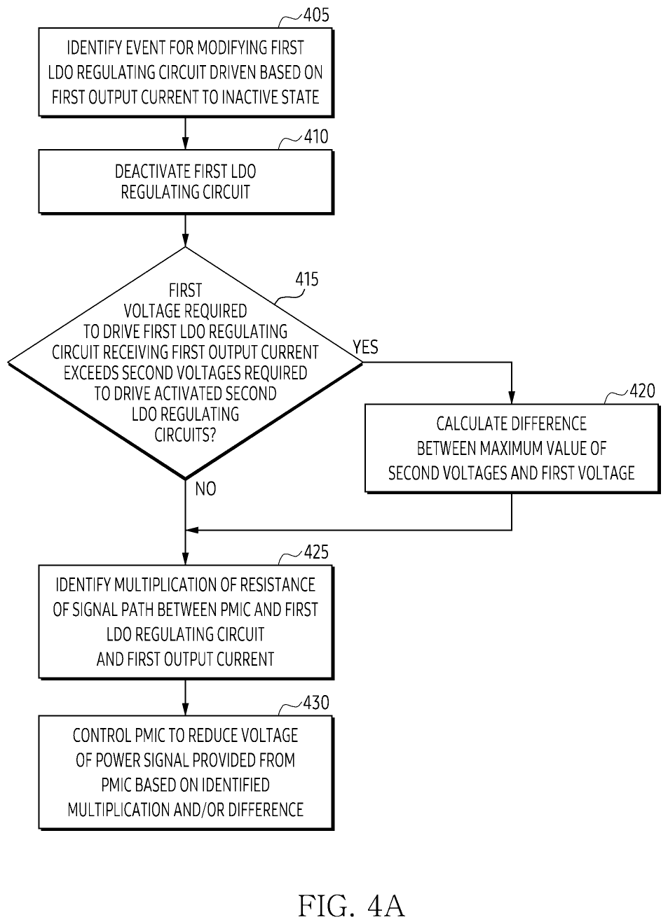

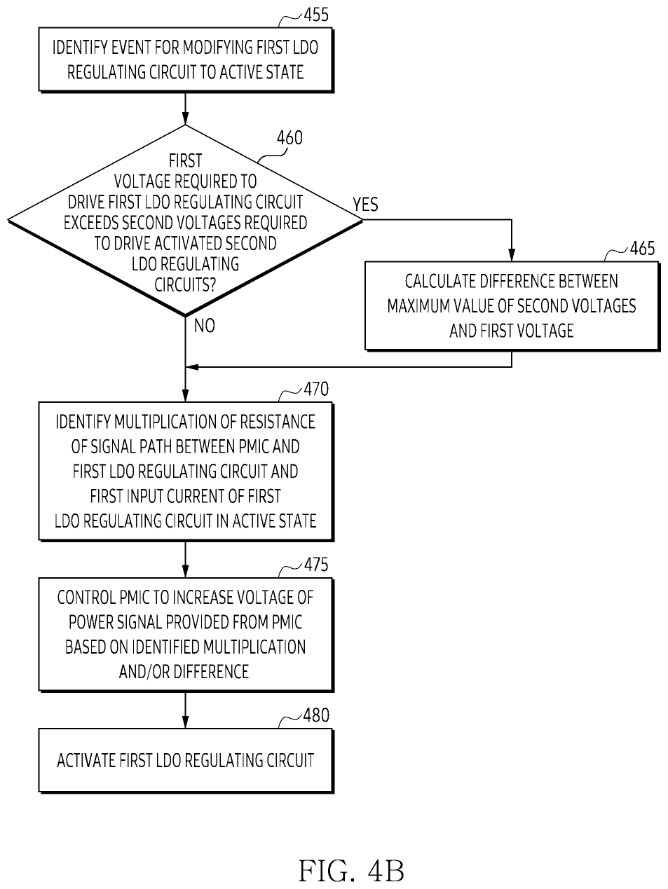

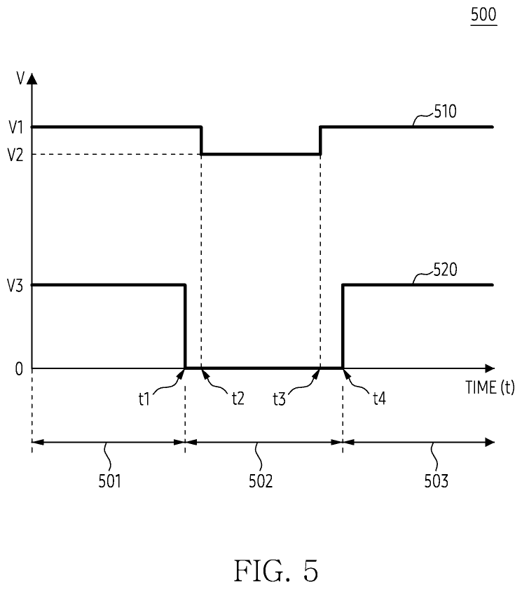

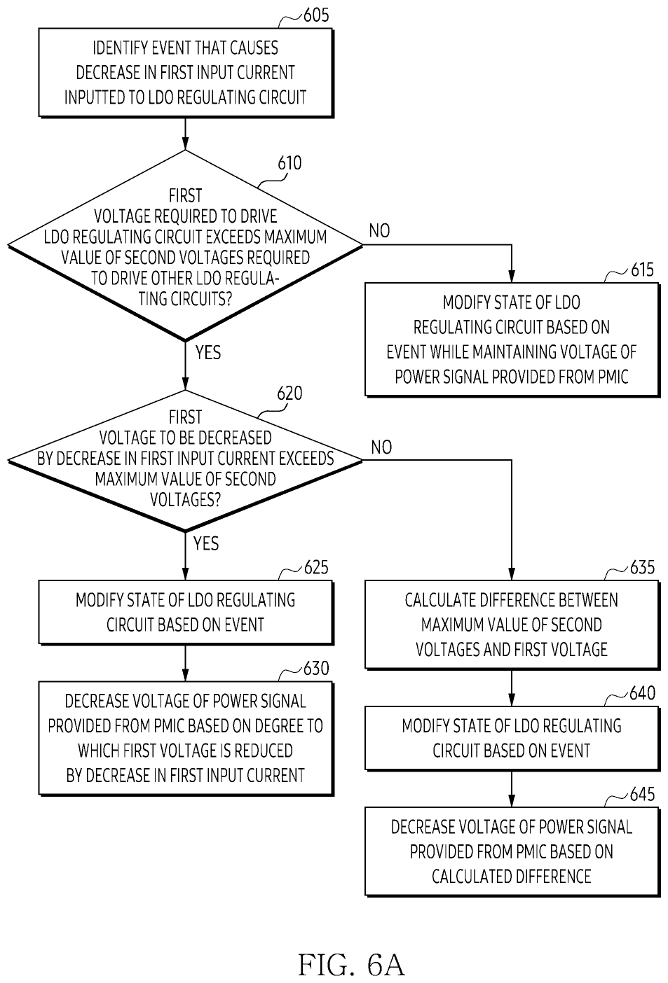

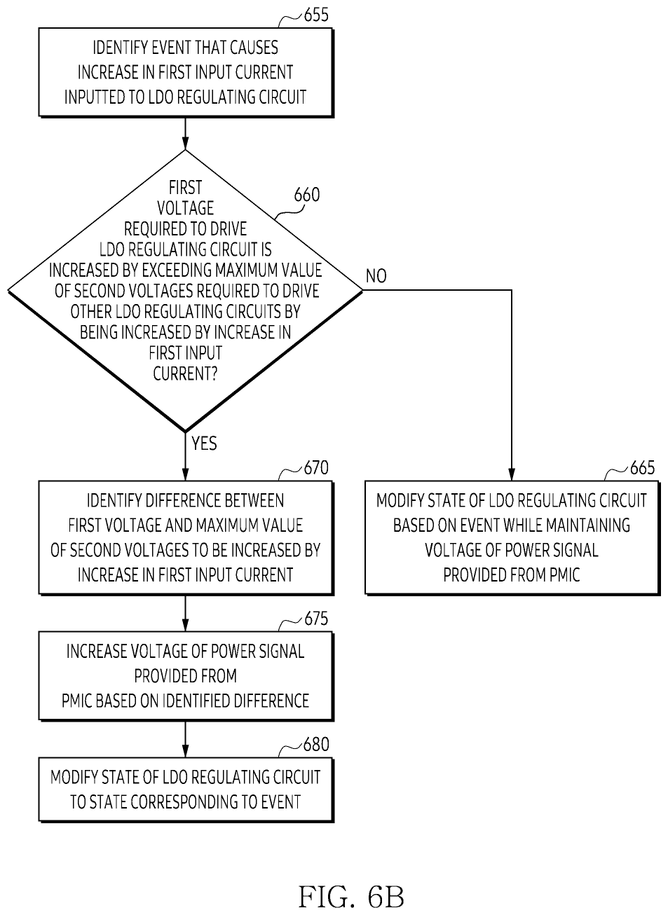

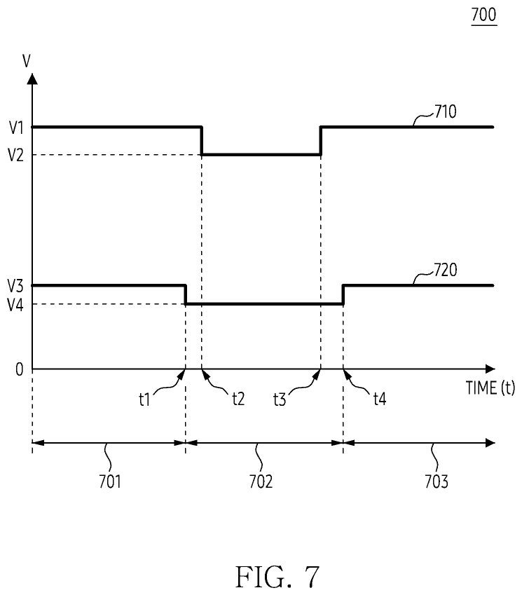

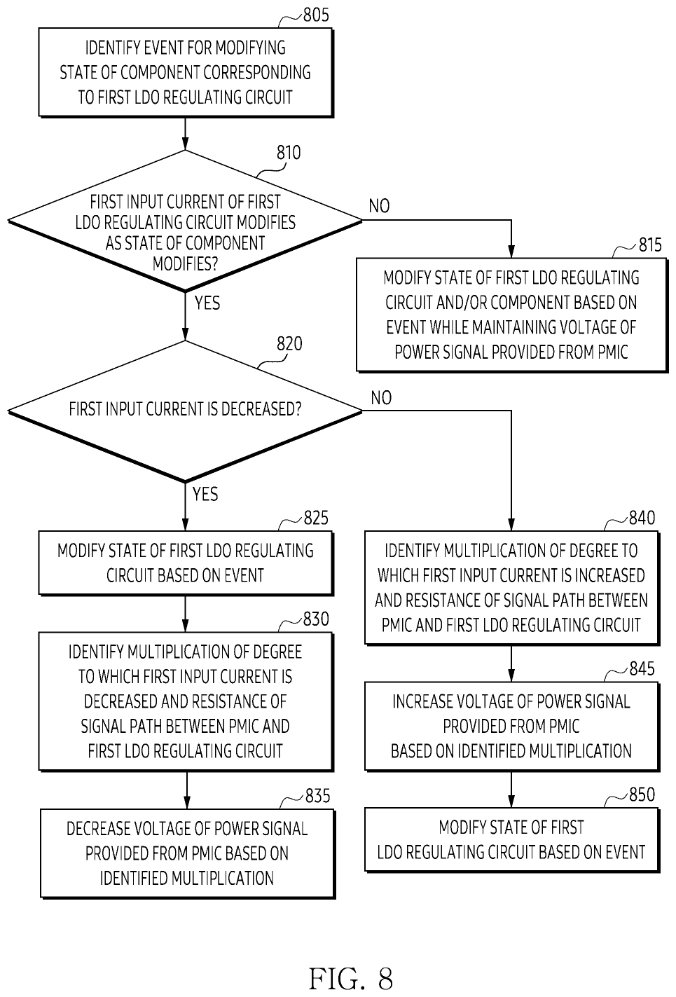

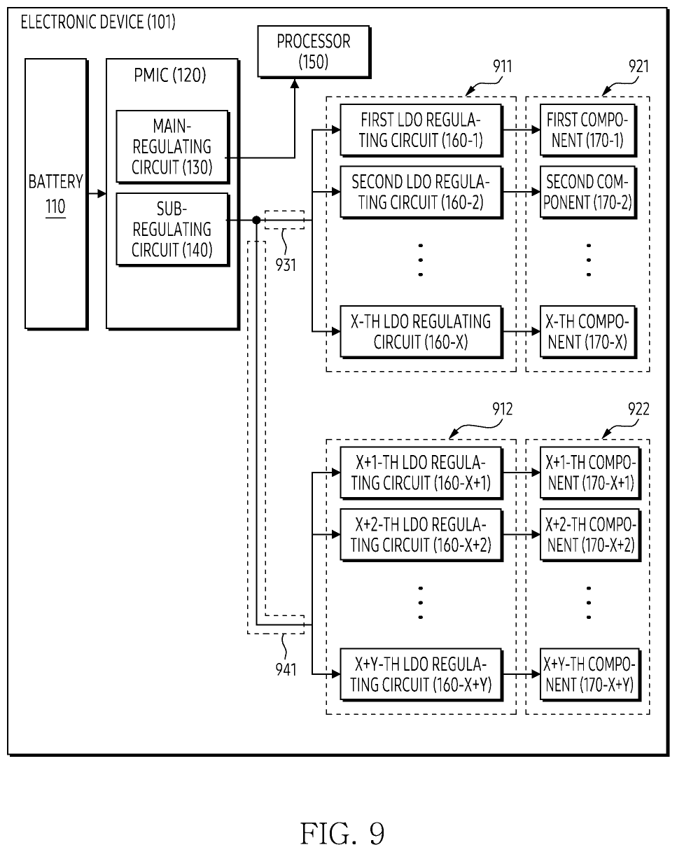

Hereinafter, an operation of the electronic device 101 in each of a case in which the input currents of the components 170 increase and a case in which the input currents of the components 170 decrease by a modification in a state of at least one of the components 170 will be described in detail. Referring to FIGS. 4A, 4B, and 5, an operation of the electronic device 101 in a state in which at least one of the components 170 is switched between an active state and an inactive state will be described. Referring to FIGS. 6A, 6B, and 7, an operation of the electronic device 101 in a state in which at least one input current of the components 170 is increased or decreased will be described. Referring to FIG. 8, an operation of the electronic device 101 for an event for modifying the state of at least one of the components 170 will be described. Referring to FIG. 9, an operation of the electronic device 101 for controlling the sub-regulating circuit 140 connected to a plurality of components 170 through a plurality of signal paths will be described.

FIGS. 4A to 4B illustrate an example of a flowchart of an operation of an electronic device for controlling an LDO regulating circuit. The electronic device 101 and/or the processor 150 of FIGS. 1 and 3 may perform the operation described with reference to FIGS. 4A to 4B. The controller 310 of FIG. 3 may perform the operation described with reference to FIGS. 4A to 4B. The LDO regulating circuit of FIGS. 4A to 4B may be included in the LDO regulating circuits 160 of FIGS. 1 and 3. The operation described with reference to FIGS. 4A and 4B may be associated with at least one of the operations of FIG. 2.

Referring to FIG. 4A, in operation 405, a processor of the electronic device according to an embodiment may identify an event for modifying a first LDO regulating circuit (e.g., the first LDO regulating circuit 160-1 of FIG. 1) driven based on a first output current to (correspond or respond to) an inactive state. A plurality of LDO regulating circuits (e.g., the LDO regulating circuits 160 of FIG. 1) including the first LDO regulating circuit may be connected to a sub-regulating circuit (e.g., the sub-regulating circuit 140 of FIG. 1) of a PMIC (e.g., the PMIC 120 of FIG. 1). The event may be generated by an instruction and/or an application programming interface (API) for deactivating a first component (e.g., the first component 170-1 of FIG. 1) corresponding to the first LDO regulating circuit. The first output current of the operation 405 may be an input current (or a consumption current) of the first component corresponding to the first LDO regulating circuit. For example, the first output current of the operation 405 may be associated with a state of the first component. The processor may identify the event of the operation 405 while the first LDO regulating circuit is activated.

Referring to FIG. 4A, in operation 410, the processor of the electronic device according to an embodiment may deactivate the first LDO regulating circuit. In the operation 410, the processor may reduce an output current of the first LDO regulating circuit to substantially zero from the first output current of the operation 405 by controlling the first LDO regulating circuit and/or the first component. The first component may be deactivated by the deactivated first LDO regulating circuit. For example, based on the operation 410, the processor may at least temporarily cease execution of a function based on the first component.

Referring to FIG. 4A, in operation 415, the processor of the electronic device according to an embodiment may identify whether a first voltage required (or desired) to drive the first LDO regulating circuit that provides the first output current exceeds second voltages required (or desired) to drive activated second LDO regulating circuits. The first output current and/or the first voltage may be identified based on profile information stored in memory (e.g., the memory 320 of FIG. 2). The first voltage may be matched to a sum of a voltage required to drive the first component and a voltage drop of the first LDO regulating circuit with respect to the first output current. The second voltages may be identified from profile information of second components corresponding to the second LDO regulating circuits. In a state that the first voltage exceeds the second voltages (415-YES), the processor may perform operation 420. In a state that the first voltage is less than or equal to the second voltages (415-NO), the processor may perform operation 425.

Referring to FIG. 4A, in the operation 420, the processor of the electronic device according to an embodiment may calculate a difference between a maximum value of the second voltages and the first voltage when the first voltage exceeds the second voltages (415-YES). The first voltage exceeding the second voltages may mean that a minimum voltage required to drive all of activated LDO regulating circuits among the plurality of LDO regulating circuits is matched to the first voltage before the first LDO regulating circuit is deactivated based on the operation 410. By the deactivation of the first LDO regulating circuit, the minimum voltage required to drive the all of the activated LDO regulating circuits among the plurality of LDO regulating circuits may be reduced from the first voltage to the maximum value of the second voltages. The processor may control the PMIC using the reduced maximum value to improve a power efficiency of the plurality of LDO regulating circuits after the operation 410.

Referring to FIG. 4A, in the operation 425, the processor of the electronic device according to an embodiment may identify a multiplication of a resistance of a signal path between the PMIC and the first LDO regulating circuit and the first output current. For example, the signal path of the operation 425 may include the signal path 180 of FIGS. 1 and/or 3. The multiplication of the operation 425 may indicate a voltage drop of the signal path based on Ohm's law. By the deactivation of the first LDO regulating circuit in the operation 410, a current flowing to the first LDO regulating circuit along the signal path may be substantially reduced to zero. The processor may identify a change of the current of the power signal according to the decrease in the current, by using the operation 425. The multiplication of the operation 425 may indicate a degree to which the voltage drop of the signal path is decreased.

Referring to FIG. 4A, in operation 430, the processor of the electronic device according to an embodiment may control the PMIC to reduce a voltage of a power signal provided from the PMIC based on the identified multiplication and/or difference. Based on the operation 430, the processor may transmit a control signal to the PMIC (or the controller 310 of FIG. 3). In a case where the first voltage exceeds the second voltages (415-YES), the processor may control the PMIC to reduce the voltage of the power signal by a sum of the difference of the operation 420 and the multiplication of the operation 425. In a case where the first voltage is less than or equal to the second voltages (415-NO), the processor may control the PMIC to reduce the voltage of the power signal by the multiplication of the operation 425.

Referring to FIG. 4A, a first timing (e.g., a timing when the operation 410 is performed) for the processor to deactivate the first LDO regulating circuit and a second timing (e.g., a timing when the operation 430 is performed) for controlling the PMIC may be different from each other. For example, referring to FIG. 4A, according to an order of the operation 410 and the operation 430, the second timing may be after the first timing. In order to effectively prevent an abnormal operation of the activated LDO regulating circuits, the processor may deactivate the first LDO regulating circuit prior to controlling the PMIC.

Referring to FIG. 4B, in operation 455, the processor of the electronic device according to an embodiment may identify an event for modifying the first LDO regulating circuit to (correspond or respond to) an active state. The event may be generated by an instruction and/or an API for activating the first component corresponding to the first LDO regulating circuit. The event of the operation 455 may be generated by a software application executed by the processor. The event of the operation 455 may be generated by a user input. The processor may identify the event of the operation 455 while the first LDO regulating circuit is deactivated.

The processor of the electronic device according to an embodiment may identify an input voltage and/or an input current of the first LDO regulating circuit in the active state before adjusting a state of the first LDO regulating circuit based on the event of the operation 455. The processor may identify, from the profile information of the memory, an input voltage and/or an input current of the first LDO regulating circuit in a state (e.g., the active state) corresponding to the event.

Referring to FIG. 4B, in operation 460, the processor of the electronic device according to an embodiment may identify whether the first voltage required (or desired) to drive the first LDO regulating circuit exceeds the second voltages required (or desired) to drive the activated second LDO regulating circuits. The first voltage and/or the second voltages may be identified from profile information on components connected to each of the first LDO regulating circuit and the second LDO regulating circuits. In a case where the first LDO regulating circuit and the second LDO regulating circuits are connected to one sub-regulating circuit in the PMIC, the first voltage and/or the second voltages may be different from a voltage of a power signal provided from the sub-regulating circuit. The first voltage may be a sum of a voltage drop of the first LDO regulating circuit switched to be in the active state by the event of the operation 455 and the voltage required to drive the first component corresponding to the first LDO regulating circuit. In a state that the first voltage exceeding the second voltages is identified (460-YES), the processor may perform operation 465. In a state that the first voltage less than or equal to the second voltages is identified (460-YES), the processor may perform operation 470.

Referring to FIG. 4B, in the operation 465, the processor of the electronic device according to an embodiment may calculate a difference between the maximum value of the second voltages and the first voltage. Before the first LDO regulating circuit is activated, a power signal provided to the activated second LDO regulating circuits may have a voltage associated with the maximum value of the second voltages for the second LDO regulating circuits. For example, before the first LDO regulating circuit is activated, a voltage of the power signal may correspond to a sum of the maximum value of the second voltages and a voltage drop of the signal path based on Equation 1. As the first voltage exceeds the second voltages, the processor may calculate, identify, or obtain the difference of the operation 465 to adjust the voltage of the power signal based on the first voltage. For example, the difference of the operation 465 may be associated with magnitude of the voltage of the power signal, which will be increased as the first LDO regulating circuit is modified to the active state.

Referring to FIG. 4B, in the operation 470, the processor of the electronic device according to an embodiment may identify a multiplication of a resistance of the signal path between the PMIC and the first LDO regulating circuit and a first input current of the first LDO regulating circuit in the active state. For example, the signal path of the operation 470 may include the signal path 180 of FIGS. 1 and/or 3. The multiplication of the operation 470 may indicate a voltage drop of the signal path indicated by Ohm's law. In a case where the first LDO regulating circuit is activated by the event of the operation 455, a current provided to LDO regulating circuits including the first LDO regulating circuit is increased, so that the voltage drop of the signal path may be increased. For example, the multiplication of the operation 470 may be associated with magnitude of the voltage of the power signal, which will be increased as the first LDO regulating circuit is modified to the active state.

Referring to FIG. 4B, in operation 475, the processor of the electronic device according to an embodiment may control the PMIC to increase the voltage of the power signal provided from the PMIC based on the identified multiplication and/or difference. Based on the operation 475, the processor may transmit a control signal indicating the difference of the operation 465, the multiplication of the operation 470, or a sum thereof to the PMIC (or a controller of the PMIC). For example, in a case where the first voltage exceeds the second voltages (460-YES), the processor may control the PMIC to increase the voltage of the power signal by the sum of the difference of the operation 465 and the multiplication of the operation 470. For example, in a case where the first voltage is less than or equal to the second voltages (460-NO), the processor may control the PMIC to increase the voltage of the power signal by the multiplication of the operation 470.

Referring to FIG. 4B, in operation 480, the processor of the electronic device according to an embodiment may activate the first LDO regulating circuit. Referring to an order and/or timings of the operations 475 and 480 of FIG. 4B, a timing at which the processor activates the first LDO regulating circuit may be after a timing of increasing the voltage of the power signal by controlling the PMIC. For example, in a case where the first LDO regulating circuit is activated faster than the increase in the voltage of the power signal, the first LDO regulating circuit may operate abnormally as the voltage required (or to be used) to drive the first LDO regulating circuit exceeds the voltage of the power signal. In order to effectively prevent the abnormal operation of the first LDO regulating circuit, the processor may control the PMIC based on the operation 475 before adjusting the state of the first LDO regulating circuit to the active state corresponding to the event of the operation 455.

In an embodiment, based on the activation of the first LDO regulating circuit, the first component connected to the first LDO regulating circuit may be activated. In an embodiment, the processor may control the first component and/or the first LDO regulating circuit using a state corresponding to the event, based on the voltage of the power signal being increased by the PMIC controlled according to the operation 470, while the current for driving the first component is identified to be increased by the event of the operation 455.

As described above, the processor of the electronic device according to an embodiment may identify the first voltage required (or desired) to drive the first component in a state indicated by the event by the first LDO regulating circuit corresponding to the first component corresponding to the event based on the event of the operation 455. The processor may identify a maximum voltage among the first voltage and the second voltages required (or desired) by the second LDO regulating circuits different from the first LDO regulating circuit. The processor may determine a voltage of a power signal provided to the first LDO regulating circuit based on the maximum voltage and a voltage reduced by a path resistance.

Hereinafter, a change in voltages in the electronic device performing the operations of FIGS. 4A to 4B will be described as an example with reference to FIG. 5.

FIG. 5 illustrates an example of a graph 500 for describing adjustment of voltages in an electronic device, according to an embodiment. The graph 500 of FIG. 5 may indicate the voltages in the electronic device adjusted by the electronic device (e.g., the electronic device 101 of FIGS. 1 and 3) and/or the processor (e.g., the processor 150 of FIG. 3) performing the operation described with reference to FIGS. 4A to 4B.

Referring to FIG. 5, the graph 500 including lines 510 and 520 synchronized on a time axis is illustrated. The line 510 may indicate a voltage of a power signal transmitted from a sub-regulating circuit (e.g., the sub-regulating circuit 140 of FIG. 1) to a plurality of LDO regulating circuits (e.g., the LDO regulating circuits 160 of FIG. 1). The line 520 may indicate an input voltage of a first component (e.g., the first component 170-1 of FIG. 1) corresponding to a first LDO regulating circuit (e.g., the first LDO regulating circuit 160-1 of FIG. 1) among the plurality of LDO regulating circuits.

In an embodiment of FIG. 5, it is assumed that the sub-regulating circuit is connected to five LDO regulating circuits corresponding to five components. It is assumed that the five LDO regulating circuits operate based on Table 1 within a first time period 501 before t1.

TABLE 1

| | | | | Voltage drop |
|---|---|---|---|---|
| | | | | of LDO |
| | Output | Output | | regulating |
| LDO regulating circuit | voltage | current | | circuit |
| First LDO regulating circuit | 3.2 V | 500 | mA | 75 mV |
| Second LDO regulating circuit | 2.8 V | 300 | mA | 50 mV |
| Third LDO regulating circuit | 3.0 V | 50 | mA | 50 mV |
| Fourth LDO regulating circuit | 3.1 V | 120 | mA | 50 mV |
| Fifth LDO regulating circuit | 3.1 V | 200 | mA | 50 mV |

Referring to Table 1, within the first time period 501, the first LDO regulating circuit may provide the first component with a power signal having a voltage of 3.2 V and a current of 500 mA. Referring to the graph 500 of FIG. 5, an input voltage V3 of the first component within the first time period 501 may be 3.2 V. In order to drive the first LDO regulating circuit to provide the power signal, a power signal having a voltage of 3.275 V (=3.2 V+75 mV) or higher may be required to the first LDO regulating circuit.

Similarly, a second LDO regulating circuit may require a voltage of 2.85 V, the third LDO regulating circuit may require a voltage of 3.05 V, and the third LDO regulating circuit and the fourth LDO regulating circuit may require a voltage of 3.15 V or higher. In an embodiment, a voltage of a power signal provided to LDO regulating circuits during the first time period 501 may correspond to a sum of a maximum value (e.g., 3.275 V required by the first LDO regulating circuit) of a voltage required by the LDO regulating circuits and a voltage drop of a signal path (e.g., the signal path 180 of FIGS. 1 and 3) through which the power signal is transmitted. In a case where it is assumed that a resistance of the signal path is 100 mΩ, the voltage drop may be 0.117 V based on a sum of 1170 mA of an output current of Table 1. Based on the voltage drop, the electronic device may set the voltage of the power signal provided from the sub-regulating circuit to a voltage of 3.392 V (=3.275 V+0.117 V) or higher.

For example, in a case where a voltage V1 of the power signal within the first time period 501 is 3.4 V, all of the five LDO regulating circuits may provide the output voltages in Table 1 to the five components corresponding to each of the five LDO regulating circuits, since the sub-regulating circuit provides a power signal having a voltage greater than or equal to the maximum value (e.g., 3.275 V) of voltages required to drive the five LDO regulating circuits within the first time period 501. Power efficiencies of the five LDO regulating circuits may correspond to Table 2 within the first time period 501 for receiving a power signal having a voltage of 3.4 V.

TABLE 2

| | Output | Input | Power |
|---|---|---|---|
| LDO regulating circuit | voltage | voltage | efficiency |
| First LDO regulating circuit | 3.2 V | 3.4 V | 94.12% |
| Second LDO regulating circuit | 2.8 V | 3.4 V | 82.35% |
| Third LDO regulating circuit | 3.0 V | 3.4 V | 88.24% |
| Fourth LDO regulating circuit | 3.1 V | 3.4 V | 91.18% |
| Fifth LDO regulating circuit | 3.1 V | 3.4 V | 91.18% |

The power efficiency of Table 2 may be associated with a ratio of an output voltage to an input voltage of the LDO regulating circuit. As a difference between the input voltage and the output voltage is large or the ratio of the output voltage to the input voltage is small, a power efficiency of the LDO regulating circuit may be reduced.

Referring to FIG. 5, it is assumed that an event for deactivating a first component corresponding to the line 520 has occurred at a timing t1. A processor identifying the event may deactivate the first LDO regulating circuit corresponding to the first component based on FIG. 4A and then reduce a voltage of a power signal by controlling the sub-regulating circuit. Referring to the line 510 of the graph 500, the voltage of the power signal may be reduced at a timing t2 after the timing t1. Referring to the line 520 corresponding to the input voltage of the first component, based on the deactivation of the first LDO regulating circuit, the output voltage of the first LDO regulating circuit may be reduced to 0 V at the timing t1. After the first LDO regulating circuit is deactivated by the event generated at the timing t1, four LDO regulating circuits (e.g., the second LDO regulating circuit to the fourth LDO regulating circuit) may be activated.

Referring to Table 1, a maximum value of input voltages of other LDO regulating circuits (e.g., the second LDO regulating circuit to the fourth LDO regulating circuit) after the first LDO regulating circuit is deactivated may be 3.15 V. Since a sum of output currents of the other LDO regulating circuits is 670 mA, the voltage drop of the signal path may be reduced to 0.067 V (=670 mA×100 mΩ) by the resistance (e.g., 100 mΩ) of the signal path. Within a second time period 502 after the timing t1, the electronic device may maintain the voltage of the power signal outputted from the sub-regulating circuit at a voltage of 3.217 V (=3.15 V+0.067 V) or higher. For example, in a case where the voltage of the power signal is reduced from 3.4 V in the first time period 501 to 3.225 V, the power efficiencies of the four activated LDO regulating circuits may correspond to Table 3.

TABLE 3

| | Output | Input | Power |
|---|---|---|---|
| LDO regulating circuit | voltage | voltage | efficiency |
| Second LDO regulating circuit | 2.8 V | 3.225 V | 86.82% (+4.47% p) |
| Third LDO regulating circuit | 3.0 V | 3.225 V | 93.02% (+4.79% p) |
| Fourth LDO regulating circuit | 3.1 V | 3.225 V | 96.12% (+4.95% p) |
| Fifth LDO regulating circuit | 3.1 V | 3.225 V | 96.12% (+4.95% p) |

Referring to Table 3, it may be seen that the power efficiencies of all of the four LDO regulating circuits is improved by more than 4 percentage points by a modification of the input voltage.

For another example, it is assumed that an event for deactivating a fifth component has occurred in a state that all of the five LDO regulating circuits are activated based on Table 1. After the fifth component is deactivated by the event, a maximum value of input voltages of four activated LDO regulating circuits (e.g., the first LDO regulating circuit to the fourth LDO regulating circuit) may be maintained at 3.275 V. After the fifth component is deactivated by the event, a sum of output currents of the four LDO regulating circuits may be decreased to 970 mA. In this case, the voltage drop of the signal path may be reduced to 0.097 V (=970 mA×100 mΩ) by a path resistance (e.g., 100 mΩ) of the signal path. The voltage drop may be a value modified by a multiplication of an output current of the fifth LDO regulating circuit and the path resistance. In the example, after the fifth component is deactivated, the electronic device may maintain the voltage of the power signal outputted from the sub-regulating circuit at a voltage of 3.372 V (=3.275 V+0.097 V) or higher. For example, in a case where the voltage of the power signal is reduced from 3.4 V to 3.38 V, power efficiencies of the four activated LDO regulating circuits may correspond to Table 4.

TABLE 4

| | Output | Input | Power |
|---|---|---|---|
| LDO regulating circuit | voltage | voltage | efficiency |
| First LDO regulating circuit | 3.2 V | 3.38 V | 94.67% (+0.56% p) |
| Second LDO regulating circuit | 2.8 V | 3.38 V | 82.84% (+0.49% p) |
| Third LDO regulating circuit | 3.0 V | 3.38 V | 88.76% (+0.52% p) |
| Fourth LDO regulating circuit | 3.1 V | 3.38 V | 91.72% (+0.54% p) |

Referring to Table 4, it may be seen that the power efficiencies of all of the four LDO regulating circuits is improved by a modification of the input voltage.

Referring back to FIG. 5, it is assumed that an event for activating the first component has occurred at a timing t3 within the second time period 502. The processor identifying the event may increase the voltage of the power signal by controlling the sub-regulating circuit based on FIG. 4B and then activate the first LDO regulating circuit corresponding to the first component. Referring to the line 510 of the graph 500, the voltage of the power signal may increase at the timing t3, and the input voltage of the first component indicated by the line 520 may increase at a timing t4 after the timing t3. Within a third time period 503 after the timing t4, the electronic device may activate the first component.

As described above, in a case where an event to reduce a current for driving a component has occurred, the electronic device may control the component or the LDO regulating circuit connected to the component in a state corresponding to the event at a first timing (e.g., the timing t1). At a second timing (e.g., the timing t2) after the first timing, the electronic device may control a PMIC to reduce the voltage of the power signal.

FIGS. 6A to 6B illustrate an example of a flowchart of an operation of an electronic device for controlling an LDO regulating circuit. The electronic device 101 and/or the processor 150 of FIGS. 1 and 3 may perform the operation described with reference to FIGS. 6A to 6B. The controller 310 of FIG. 3 may perform the operation described with reference to FIGS. 6A to 6B. The LDO regulating circuit of FIGS. 6A to 6B may be included in the LDO regulating circuits 160 of FIGS. 1 to 3. The operation described with reference to FIGS. 6A and 6B may be associated with at least one of the operations of FIGS. 2, 4A, and 4B.

Referring to FIG. 6A, in operation 605, a processor of the electronic device according to an embodiment may identify an event that causes a decrease in a first input current inputted to the LDO regulating circuit. For example, the event may include the event of the operation 405 of FIG. 4A. The event of the operation 605 may include an event for reducing an input voltage of a component corresponding to the LDO regulating circuit. The event of the operation 605 may include an event of modifying a state of the component corresponding to the LDO regulating circuit of the operation 605 into another state that causes a decrease in a consumption current of the component. For example, the event of the operation 605 may be generated by a user input for switching the state of the component corresponding to the LDO regulating circuit from a saturation state to an idle state and/or an inactive state.

Referring to FIG. 6A, in operation 610, the processor of the electronic device according to an embodiment may identify whether a first voltage required (or desired) to drive the LDO regulating circuit exceeds a maximum value of second voltages required (or desired) to drive other LDO regulating circuits. The first voltage may correspond to an input voltage required to drive the LDO regulating circuit before the event of the operation 605 occurs. For example, the first voltage and/or the second voltages may be identified from profile information stored in memory (e.g., the memory 320 of FIG. 3) of the electronic device. In a case where the first voltage, which is less than or equal to the maximum value of the second voltages, is identified (610-NO), the processor may perform operation 615. In a case where the first voltage exceeding the maximum value of the second voltages is identified (610-YES), the processor may perform operation 620.

Referring to FIG. 6A, in the operation 615, the processor of the electronic device according to an embodiment may modify a state of the LDO regulating circuit based on the event while maintaining a voltage of a power signal provided from a PMIC. Since the voltage of the power signal is maintained by the operation 615, the voltage of the power signal may be maintained at greater than or equal to the maximum value of the second voltages.

Referring to FIG. 6A, in the operation 620, the processor of the electronic device according to an embodiment may identify whether the first voltage to be decreased by the decrease in the first input current exceeds the maximum value of the second voltages. The decreased first voltage of the operation 620 may be associated with the first input current decreased by the event of the operation 605. In a case where the first voltage reduced by the decrease in the first input current exceeds the maximum value of the second voltages (620-YES), the processor may perform operation 625. In a case where the first voltage reduced by the decrease in the first input current is less than or equal to the maximum value of the second voltages (620-NO), the processor may perform operation 635.

Referring to FIG. 6A, in the operation 625, the processor of the electronic device according to an embodiment may modify the state of the LDO regulating circuit based on the event. The operation 625 may be performed similarly to the operation 410 of FIG. 4A. Based on the operation 625, the processor may modify the state of the LDO regulating circuit and/or the component corresponding to the event of the operation 605.

Referring to FIG. 6A, in operation 630, the processor of the electronic device according to an embodiment may decrease the voltage of the power signal provided from the PMIC based on a degree to which the first voltage is reduced by the decrease in the first input current. In order to effectively prevent an abnormal operation of the LDO regulating circuit, the processor may perform the operation 630 after changing the state of the LDO regulating circuit based on the operation 625. For example, the processor may reduce the voltage of the power signal by a degree to which the first voltage required to drive the LDO regulating circuit is reduced by the event. The processor may transmit a control signal for reducing the voltage of the power signal to a controller (e.g., the controller 310 of FIG. 3) of the PMIC and/or the PMIC.

Referring to FIG. 6A, in the operation 635, the processor of the electronic device according to an embodiment may calculate a difference between the maximum value of the second voltages and the first voltage. The operation 635 of FIG. 6A may be performed similarly to the operation 420 of FIG. 4A. The operation 635 may be performed in a case where a maximum value of voltages required to drive LDO regulating circuits is modified by a decrease in the first voltage.

Referring to FIG. 6A, in operation 640, the processor of the electronic device according to an embodiment may modify the state of the LDO regulating circuit based on the event. Referring to FIG. 6A, in operation 645, the processor of the electronic device according to an embodiment may decrease the voltage of the power signal provided from the PMIC based on the calculated difference. Similarly to the order of the operations 410 and 430 of FIG. 4A, in order to effectively prevent the abnormal operation of the LDO regulating circuit, the operation 645 of controlling the PMIC may be performed after the operation 640 of modifying the state of the LDO regulating circuit. The first input current inputted to the LDO regulating circuit may be decreased by the LDO regulating circuit in the state modified based on the operation 640. Based on the voltage of the power signal decreased based on the operation 645, power efficiencies of all of the LDO regulating circuits receiving the power signal may be improved. The operation 645 of FIG. 6 may be performed similarly to the operation 430 of FIG. 4A.

Referring to FIG. 6B, in operation 655, the processor of the electronic device according to an embodiment may identify an event that causes an increase in the first input current inputted to the LDO regulating circuit. The event of the operation 655 may include the event of the operation 455 of FIG. 4B. The event of the operation 655 may include an event for increasing an input voltage of the component corresponding to the LDO regulating circuit. The event of the operation 655 may include an event of modifying the state of the component corresponding to the LDO regulating circuit into another state that causes an increase in the consumption current of the component. For example, the event of the operation 655 may be generated by a user input for switching the state of the component corresponding to the LDO regulating circuit from the inactive state to the idle state and/or the saturation state. For example, the event of the operation 655 may be generated by a user input for switching the state of the component from the idle state to the saturation state.

Referring to FIG. 6B, in operation 660, the processor of the electronic device according to an embodiment may identify whether the first voltage required (or desired) to drive the LDO regulating circuit is increased by exceeding the maximum value of the second voltages required (or desired) to drive the other LDO regulating circuits by being increased by the increase in the first input current. As the first input current is increased by the event of the operation 655, a voltage drop of the LDO regulating circuit may be increased, and a voltage required to drive the LDO regulating circuit may be increased. In a case where the first voltage is increased in a range less than or equal to the maximum value (660-NO), the processor may perform operation 665. In a case where the first voltage is increased exceeding the maximum value (660-YES), the processor may perform operation 670.

Referring to FIG. 6B, in the operation 665, the processor of the electronic device according to an embodiment may modify the state of the LDO regulating circuit based on the event while maintaining the voltage of the power signal provided from the PMIC. For example, the voltage of the power signal may be maintained based on the maximum value of the second voltages and the voltage drop of the signal path.

Referring to FIG. 6B, in the operation 670, the processor of the electronic device according to an embodiment may identify the difference between the first voltage and the maximum value of the second voltages to be increased by the increase in the first input current. The processor may perform the operation 670 of FIG. 6B similarly to the operation 465 of FIG. 4B.

Referring to FIG. 6B, in operation 675, the processor of the electronic device according to an embodiment may increase the voltage of the power signal provided from the PMIC based on the identified difference. Referring to FIG. 6B, in operation 680, the processor of the electronic device according to an embodiment may modify the state of the LDO regulating circuit to a state corresponding to the event. An order of the operations 675 and 680 of FIG. 6B may be performed similarly to the order of the operations 475 and 480 of FIG. 4B. For example, the processor may perform operation 680 after increasing the voltage of the power signal based on the operation 675 to effectively prevent an abnormal operation caused by receiving a voltage less than the voltage required to drive the LDO regulating circuit. The operation 675 of FIG. 6B may be performed similarly to the operation 475 of FIG. 4B. The operation 680 of FIG. 6B may be performed similarly to the operation 480 of FIG. 4B.

Hereinafter, a change in the voltages in the electronic device performing the operations of FIGS. 6A to 6B will be described as an example with reference to FIG. 7.

FIG. 7 illustrates an example of a graph 700 for describing adjustment of voltages in an electronic device, according to an embodiment. The graph 700 of FIG. 7 may indicate the voltages in the electronic device adjusted by an electronic device 101 (e.g., the electronic device 101 of FIGS. 1 and 3) and/or a processor (e.g., the processor 150 of FIG. 3) performing the operation described with reference to FIGS. 6A to 6B.

Referring to FIG. 7, the graph 700 including lines 710 and 720 synchronized on a time axis is illustrated. The line 710 may indicate a voltage of a power signal transmitted from a sub-regulating circuit (e.g., the sub-regulating circuit 140 of FIG. 1) to a plurality of LDO regulating circuits (e.g., the LDO regulating circuits 160 of FIG. 1). The line 720 may indicate an input voltage of a first component (e.g., the first component 170-1 of FIG. 1) corresponding to a first regulating circuit (e.g., the LDO regulating circuit 160-1 of FIG. 1) among the plurality of LDO regulating circuits.

In an embodiment of FIG. 7, it is assumed that the sub-regulating circuit is connected to five LDO regulating circuits corresponding to five components, similarly to the assumption of FIG. 5. In addition, it is assumed that the five LDO regulating circuits operate based on Table 1 within a first time period 701 before the t1 of FIG. 7. For example, it is assumed that within the first time period 701, the voltage of the power signal indicated by the line 710 is V1 (=3.4 V). It is assumed that the input voltage of the first component indicated by the line 720 within the first time period 701 is V3 (=3.2 V).

At the timing t1 of FIG. 7, it is assumed that an event for decreasing an input current and/or the input voltage of the first component corresponding to the line 720 has occurred. A processor identifying the event may control a first LDO regulating circuit corresponding to the first component based on FIG. 6A and then control the sub-regulating circuit. Referring to FIG. 7, at the timing t1, by adjusting the first LDO regulating circuit, the processor may reduce the input current and/or the input voltage of the first component, and control the sub-regulating circuit at a timing t2 after the timing t1.

For example, it is assumed that an event for reducing the input voltage of the first component to 3.1 V has occurred at the timing t1. At the timing t1, the input voltage of the first component indicated by the line 720 may be reduced to V4 (=3.1 V). Within a second time period 702 after the timing t1, a maximum value of voltages required to drive LDO regulating circuits may correspond to a combination of the reduced input voltage of the first LDO regulating circuit and a voltage drop of the first LDO regulating circuit. After the timing t1, the electronic device may reduce the voltage of the power signal of the sub-regulating circuit by controlling a PMIC based on a degree (e.g., 0.1 V) to which the input voltage is reduced. For example, at the timing t2, the voltage of the power signal indicated by the line 710 may be reduced to V2 (=3.3 V). After the timing t2, power efficiencies of the LDO regulating circuits may be modified as illustrated in Table 5 by a power signal having a voltage reduced to V2.

TABLE 5

| | Output | Input | Power |
|---|---|---|---|
| LDO regulating circuit | voltage | voltage | efficiency |
| First LDO regulating circuit | 3.1 V | 3.3 V | 93.94%(−0.17% p) |
| Second LDO regulating circuit | 2.8 V | 3.3 V | 84.85%(+2.54% p) |
| Third LDO regulating circuit | 3.0 V | 3.3 V | 90.91%(+2.68% p) |
| Fourth LDO regulating circuit | 3.1 V | 3.3 V | 93.94%(+2.77% p) |
| Fifth LDO regulating circuit | 3.1 V | 3.3 V | 93.94%(+2.77% p) |

Referring to Table 5, the power efficiency of the second LDO regulating circuit to the fifth LDO regulating circuit, which is different from the first LDO regulating circuit, may be improved according to a modification of the input voltage.

For another example, it is assumed that an event for reducing an input current of a second component has occurred in a state that all of the five LDO regulating circuits are activated based on Table 1. In a case where the input current of the second component is reduced from 300 mA to 30 mA in Table 1 by the event, the processor may identify that a voltage drop of a signal path is decreased by 0.027 V (=270 mA×100 mΩ) based on a degree (270 mA) to which the input current is reduced and a path resistance (100 mΩ) of the signal path. Based on a degree to which the voltage drop is decreased, the processor may reduce the voltage of the power signal by controlling the PMIC. For example, the processor may reduce the voltage of the power signal to 3.373 V (=3.4 V−0.027 V) by controlling the PMIC. In the example, the power efficiencies of the five LDO regulating circuits may correspond to Table 6.

TABLE 6

| | Output | Input | Power |
|---|---|---|---|
| LDO regulating circuit | voltage | voltage | efficiency |
| First LDO regulating circuit | 3.2 V | 3.373 V | 94.87%(+0.76% p) |
| Second LDO regulating circuit | 2.8 V | 3.373 V | 83.01%(+0.70% p) |
| Third LDO regulating circuit | 3.0 V | 3.373 V | 88.94%(+0.71% p) |
| Fourth LDO regulating circuit | 3.1 V | 3.373 V | 91.91%(+0.74% p) |
| Fifth LDO regulating circuit | 3.1 V | 3.373 V | 91.91%(+0.74% p) |

Referring to Table 6, since the input voltages of all of the plurality of LDO regulating circuits is decreased in common, the power efficiencies of the all of the plurality of LDO regulating circuits may be improved.

Referring back to FIG. 7, it is assumed that an event for increasing the input voltage of the first component to V3 (=3.2 V) has occurred at a timing t3 within the second time period 702. The processor identifying the event may increase the voltage of the power signal by controlling the sub-regulating circuit based on FIG. 6B. Referring to FIG. 7, before increasing the input voltage of the first component indicated by the line 720, the voltage of the power signal indicated by the line 710 may be increased. For example, at the timing t3, the voltage of the power signal may increase to V1. At a timing t4 after the timing t3, the processor may increase the input voltage of the first component to V3. Within a third time period 703 after the timing t4, the processor may modify a state of the first component to a state corresponding to the event.

FIG. 8 illustrates an example of a flowchart of an operation of an electronic device for controlling a PMIC based on a state of a component. The electronic device 101 and/or the processor 150 of FIGS. 1 and 3 may perform the operation described with reference to FIG. 8. The controller 310 of FIG. 3 may perform the operation described with reference to FIG. 8. The PMIC of FIG. 8 may be included in the PMIC 120 of FIGS. 1 and 3. The operation described with reference to FIG. 8 may be associated with at least one of the operations of FIGS. 2, 4A, 4B, 6A, and 6B.

Referring to FIG. 8, in operation 805, a processor of the electronic device according to an embodiment may identify an event for modifying a state of a component corresponding to a first LDO regulating circuit. The operation 805 of FIG. 8 may be performed similarly to the operation 220 of FIG. 2. The operation 805 of FIG. 8 may include the operation 405 of FIG. 4A, the operation 455 of FIG. 4B, the operation 605 of FIG. 6A, and the operation 655 of FIG. 6B. As the state of the component is modified, at least one selected from a voltage drop, an input voltage, or an input current of the first LDO regulating circuit corresponding to the component may be modified.

Referring to FIG. 8, in operation 810, the processor of the electronic device according to an embodiment may identify whether a first input current of the first LDO regulating circuit modifies as the state of the component is modified. In an embodiment, the processor may perform the operation 810 before the state of the component is modified by the event of the operation 805. For example, the processor may identify an input current corresponding to a state associated with the event from profile information stored in memory (e.g., the memory 320 of FIG. 2). In a case where the first input current of the first LDO regulating circuit is not modified (810-NO), the processor may perform operation 815. Based on identifying the modification of the first input current, the processor may perform operation 820.

Referring to FIG. 8, in the operation 815, the processor of the electronic device according to an embodiment may modify a state of the first LDO regulating circuit and/or the component based on the event while maintaining a voltage of a power signal provided from the PMIC. The power signal of the operation 815 may be outputted from a sub-regulating circuit (e.g., the sub-regulating circuit 140 of FIGS. 1 and 3) of the PMIC.

Referring to FIG. 8, in the operation 820, the processor of the electronic device according to an embodiment may identify whether the first input current is decreased. The processor may perform the operation 820 using the profile information. In a case where the first input current is decreased (820-YES), the processor may perform operation 825. In a case where the first input current is increased (820-NO), the processor may perform operation 840.

Referring to FIG. 8, in the operation 825, the processor of the electronic device according to an embodiment may modify the state of the first LDO regulating circuit based on the event. The operation 825 of FIG. 8 may be performed similarly to at least one selected from the operation 410 of FIG. 4A and the operation 625 and 640 of FIG. 6A. For example, the processor may modify the state of the first LDO regulating circuit and/or the component based on the event.

Referring to FIG. 8, in operation 830, the processor of the electronic device according to an embodiment may identify a multiplication of a degree to which the first input current is decreased and a resistance of a signal path between the PMIC and the first LDO regulating circuit. The processor may identify the degree to which the first input current is decreased by using the profile information. The multiplication identified based on the operation 830 may correspond to a degree to which a voltage drop of the signal path is reduced by the modification of the state of the first LDO regulating circuit. The processor may perform the operation 830 similarly to the operation 425 of FIG. 4A.

Referring to FIG. 8, in operation 835, the processor of the electronic device according to an embodiment may decrease the voltage of the power signal provided from the PMIC based on the identified multiplication. For example, the processor may transmit a control signal to reduce the voltage of the power signal by the multiplication identified based on the operation 830 to the PMIC. The processor may perform the operation 835 similarly to the operation 430 of FIG. 4A. Based on an order of the operations 825 and 835, the processor may prevent the voltage of the power signal from being reduced earlier than a maximum value of voltages to drive activated LDO regulating circuits including the first LDO regulating circuit.

Referring to FIG. 8, in the operation 840, the processor of the electronic device according to an embodiment may identify a multiplication of a degree to which the first input current is increased and the resistance of the signal path between the PMIC and the first LDO regulating circuit. The processor may perform the operation 840 similarly to the operation 470 of FIG. 4B. The multiplication identified based on the operation 840 may correspond to a degree to which the voltage drop of the signal path is increased by the modification of the state of the first LDO regulating circuit.

Referring to FIG. 8, in operation 845, the processor of the electronic device according to an embodiment may increase the voltage of the power signal provided from the PMIC based on the multiplication identified by the operation 840. The processor may transmit a control signal to increase the voltage of the power signal by the multiplication identified based on the operation 845 to the PMIC. The processor may perform the operation 845 similarly to the operation 475 of FIG. 4B.

Referring to FIG. 8, in operation 850, the processor of the electronic device according to an embodiment may modify the state of the first LDO regulating circuit based on the event. The processor may perform the operation 850 of FIG. 8 similarly to the operation 480 of FIG. 4B. Based on an order of the operations 845 and 850, the processor may prevent the voltage of the power signal from being increased later than a voltage required by the first LDO regulating circuit is increased by the event.

As described above, the processor of the electronic device according to an embodiment may control the PMIC and/or the sub-regulating circuit that provides a power signal to LDO regulating circuits corresponding to components based on a modification of a consumption current and/or a voltage of the components. The processor may improve power efficiencies of the LDO regulating circuits by controlling the PMIC and/or the sub-regulating circuit. The processor may modify the voltage of the power signal based on a voltage drop of a signal path between the sub-regulating circuit of the PMIC and a plurality of LDO regulating circuits. The processor may modify the voltage of the power signal based on a minimum voltage for ensuring driving of the LDO regulating circuits.

Hereinafter, an embodiment of the electronic device including the sub-regulating circuit connected to different signal paths will be described with reference to FIG. 9.

FIG. 9 illustrates an example of a block diagram of an electronic device 101 according to an embodiment. The electronic device 101 of FIG. 9 may be an example of the electronic device 101 of FIGS. 1 and/or 3.

Referring to FIG. 9, a sub-regulating circuit 140 of the electronic device 101 may transmit a power signal to different signal paths 931 and 941. The sub-regulating circuit 140 may provide the power signal to LDO regulating circuits 911 of a first group and components 921 of the first group through the first signal path 931. The sub-regulating circuit 140 may provide the power signal to LDO regulating circuits 912 of a second group and components 922 of the second group through the second signal path 941. Referring to FIG. 9, the first group of X LDO regulating circuits 911 and the second group of Y LDO regulating circuits 912 are exemplarily illustrated, but an embodiment is not limited thereto. Here, X and Y are natural numbers greater than 1.

A processor 150 of the electronic device 101 according to an embodiment may determine a voltage of a power signal outputted from the sub-regulating circuit 140 based on a maximum value of voltages required to drive each of (X+Y) LDO regulating circuits. In a case where a state of at least one selected from the components 921 of the first group and the components 922 of the second group is modified, the processor 150 may identify whether the maximum value is adjusted by the component in the modified state. In a case where the maximum value is adjusted, the processor 150 may modify the voltage of the power signal outputted from the sub-regulating circuit 140 based on the adjusted maximum value.

For example, in a case where a state of an X-th LDO regulating circuit 160-X and/or an X-th component 170-X is modified, the processor 150 may identify voltages required (or desired) to drive the LDO regulating circuits 912 of the second group as well as the LDO regulating circuits 911 of the first group including the X-th LDO regulating circuit 160-X. The processor 150 identifying a maximum value of the voltages required to drive all of the LDO regulating circuits included in the first group and the second group may provide a power signal having a voltage based on the maximum value to not only the LDO regulating circuits 911 of the first group but also all of the LDO regulating circuits 912 of the second group by controlling the sub-regulating circuit 140 and/or the PMIC 120 based on the maximum value.

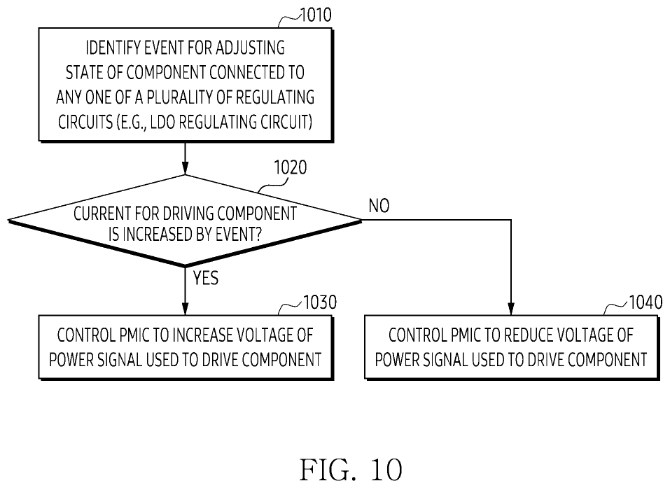

FIG. 10 illustrates an example of a flowchart of an operation of an electronic device for controlling a PMIC based on a state of a component. The electronic device 101 and/or the processor 150 of FIGS. 1 and 3 may perform the operation described with reference to FIG. 10. The controller 310 of FIG. 3 may perform the operation described with reference to FIG. 10. The component of FIG. 10 may correspond to an example of the components 170 of FIGS. 1, 3, and 9. The PMIC of FIG. 10 may correspond to the PMIC 120 of FIGS. 1, 3, and 9. The operation described with reference to FIG. 10 may be associated with at least one of the operations of FIGS. 2, 4A, 4B, 6A, 6B, and 8.

Referring to FIG. 10, in operation 1010, a processor of the electronic device according to an embodiment may identify an event for adjusting a state of a component connected to any one of a plurality of regulating circuits (e.g., the LDO regulating circuits 160 of FIGS. 1, 3, and 9) (e.g., an LDO regulating circuit). The operation 1010 may be performed similarly to the operation 220 of FIG. 2, the operation 405 of FIG. 4A, the operation 455 of FIG. 4B, the operation 605 of FIG. 6A, the operation 655 of FIG. 6B, and the operation 805 of FIG. 8.

Referring to FIG. 10, in operation 1020, the processor of the electronic device according to an embodiment may identify whether a current for driving the component is increased by the event. The processor may identify the current of the operation 1020 based on profile information stored in memory (e.g., the memory 320 of FIG. 3). In a case where the current of the operation 1020 is increased by the event (1020-YES), the processor may perform operation 1030. In a case where the current of the operation 1020 is decreased by the event (1020-NO), the processor may perform operation 1040.

Referring to FIG. 10, in the operation 1030, the processor of the electronic device according to an embodiment may control the PMIC to increase a voltage of a power signal used to drive the component. For example, the processor may control the PMIC based on a path resistance between the PMIC and a plurality of regulating circuits and the current that will be increased by the event. The processor may increase the voltage of the power signal provided to the plurality of regulating circuits by controlling the PMIC, and then modify the state of the component of the operation 1010 based on the event. The processor may increase the voltage of the power signal based on a voltage drop of a signal path increased by the increase in the current and/or a voltage drop of the LDO regulating circuit increased by the increase in the current.

Referring to FIG. 10, in the operation 1040, the processor of the electronic device according to an embodiment may control the PMIC to reduce the voltage of the power signal used to drive the component. For example, the processor may control the PMIC based on the path resistance and the current to be reduced by the event. The processor may reduce the current for driving the component by controlling the component and/or the LDO regulating circuit, and then reduce the voltage of the power signal by controlling the PMIC. The processor may reduce the voltage of the power signal based on the voltage drop of a signal path decreased by a decrease in the current and/or the voltage drop of the LDO regulating circuit decreased by the decrease in the current.

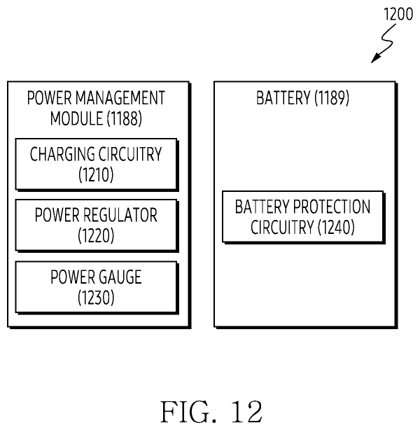

Hereinafter, a structure of the electronic device 101 and/or the PMIC 120 described with reference to FIGS. 1, 3, and 9 will be described with reference to FIGS. 11 to 12.

FIG. 11 is a block diagram illustrating an electronic device 1101 in a network environment 1100 according to various embodiments. Referring to FIG. 11, the electronic device 1101 in the network environment 1100 may communicate with an electronic device 1102 via a first network 1198 (e.g., a short-range wireless communication network), or at least one selected from an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or U-plane latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

FIG. 12 is a block diagram 1200 illustrating the power management module 1188 and the battery 1189 according to various embodiments. Referring to FIG. 12, the power management module 1188 may include charging circuitry 1210, a power adjuster 1220, or a power gauge 1230. The charging circuitry 1210 may charge the battery 1189 by using power supplied from an external power source outside the electronic device 1101. According to an embodiment, the charging circuitry 1210 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 1189, and may charge the battery 1189 using the selected charging scheme. The external power source may be connected with the electronic device 1101, for example, directly via the connecting terminal 1178 or wirelessly via the antenna module 1197.

The power adjuster 1220 may generate a plurality of powers having different voltage levels or different current levels by adjusting a voltage level or a current level of the power supplied from the external power source or the battery 1189. The power adjuster 1220 may adjust the voltage level or the current level of the power supplied from the external power source or the battery 1189 into a different voltage level or current level appropriate for each of some of the components included in the electronic device 1101. According to an embodiment, the power adjuster 1220 may be implemented in the form of a low drop out (LDO) regulator or a switching regulator. The power gauge 1230 may measure use state information about the battery 1189 (e.g., a capacity, a number of times of charging or discharging, a voltage, or a temperature of the battery 1189).

The power management module 1188 may determine, using, for example, the charging circuitry 1210, the power adjuster 1220, or the power gauge 1230, charging state information (e.g., lifetime, over voltage, low voltage, over current, over charge, over discharge, overheat, short, or swelling) related to the charging of the battery 1189 based at least in part on the measured use state information about the battery 1189. The power management module 1188 may determine whether the state of the battery 1189 is normal or abnormal based at least in part on the determined charging state information. If the state of the battery 1189 is determined to abnormal, the power management module 1188 may adjust the charging of the battery 1189 (e.g., reduce the charging current or voltage, or stop the charging). According to an embodiment, at least some of the functions of the power management module 1188 may be performed by an external control device (e.g., the processor 1120).

The battery 1189, according to an embodiment, may include a protection circuit module (PCM) 1240. The PCM 1240 may perform one or more of various functions (e.g., a pre-cutoff function) to effectively prevent a performance deterioration of, or a damage to, the battery 1189. The PCM 1240, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment, at least part of the charging state information or use state information regarding the battery 1189 may be measured using a corresponding sensor (e.g., a temperature sensor) of the sensor module 1176, the power gauge 1230, or the power management module 1188. According to an embodiment, the corresponding sensor (e.g., a temperature sensor) of the sensor module 1176 may be included as part of the PCM 1240, or may be disposed near the battery 1189 as a separate device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A method for improving a power efficiency of an electronic device may be desired. A method for improving a power efficiency of LDO regulating circuits included in the electronic device may be desired. A method for adjusting a voltage of a buck-converter (e.g., the sub-regulating circuit 140 of FIG. 1) in a PMIC configured to provide a power signal to the LDO regulating circuits included in the electronic device may be desired. The electronic device (e.g., the electronic device 101 of FIGS. 1, 3 and/or 9) according to an embodiment as described above may include a power management integrated circuit (PMIC) (e.g., the PMIC 120 of FIG. 1), a plurality of regulating circuits (e.g., the plurality of LDO regulating circuits 160 of FIG. 1) which receives a power signal of the PMIC, memory (e.g., the memory 320 of FIG. 3) storing executable instructions, and at least one processor (e.g., the processor 150 of FIG. 1) which executes the instructions by accessing the memory. The processor may be configured to identify an event for adjusting a driving state of a component (e.g., the plurality of components 170 of FIG. 1) connected to one of the plurality of regulating circuits. The at least one processor may be configured to, in response to identifying that a current for driving the component is increased by the identified event, control the PMIC to increase a voltage of the power signal. The at least one processor may be configured to, in response to identifying that a current for driving the component is decreased by the identified event, control the PMIC to decrease the voltage of the power signal.

For example, the at least one processor may be configured to, in response to identifying that the current for driving the component is decreased by the event, control a regulating circuit connected to the component or the component in the state corresponding to the event at a first timing. The at least one processor may be configured to control, at a second timing after the first timing, the PMIC to increase the voltage of the power signal.

For example, the processor may be configured to, based on a current for driving the component to be increased or be decreased by the event, identify a first voltage to be used by a regulating circuit corresponding to the component to drive the component in the state. The processor may be configured to identify a maximum voltage among the first voltage and second voltages to be used by other regulating circuits different from the regulating circuit. The processor may be configured to, based on a voltage changed by the maximum voltage and a path resistance between the PMIC and the plurality of regulating circuits, determine the voltage of the power signal.

For example, the at least one processor may be configured to, based on the voltage of the power signal being increased by controlling of the PMIC while the current for driving the component is increased by the event, control the regulating circuit connected to the component or the component in the state corresponding to the event.

For example, the regulating circuit corresponding to the component may be configured to obtain, based on a low-drop out (LDO) from the power signal of a first voltage, a power signal of a second voltage smaller than the first voltage which is to be used to drive the component.

For example, the at least one processor may be configured to, based on a state of the component corresponding to the event, identify the second voltage and a current to be used to drive the component.

For example, the electronic device may further include memory (e.g., the memory 320 of FIG. 3). The at least one processor may be configured to identify the second voltage and the current to be used to drive the component in the state, from profile information that is associated with the component and is stored in the memory.

For example, the at least one processor may be configured to, based on a serial interface connecting the processor and the PMIC, transmit a control signal to increase or decrease the voltage of the power signal to the PMIC. The serial interface may be associated with at least one selected from an inter-integrated circuit (I2C), a system power management interface (SPMI), a serial peripheral interface (SPI), or a mobile industry processor interface (MIPI).

For example, the power signal may be a first power signal. The PMIC may include a main-regulating circuit to generate a second power signal to drive the processor from a battery of the electronic device. The PMIC may include a sub-regulating circuit to generate the first power signal. The PMIC may include a controller, which is connected to the processor through the SPMI, to control the sub-regulating circuit based on the control signal.

For example, the controller may be configured to adjust a voltage of the sub-regulating circuit based on a parameter inputted to a register based on the control signal.

A method of an electronic device according to an embodiment as described above may include identifying (e.g., the operation 1010 of FIG. 10) an event for adjusting a driving state of a component connected to one of a plurality of regulating circuits of the electronic device which receives a power signal of a power management integrated circuit (PMIC) of the electronic device. The method may include, in response to identifying that a current for driving the component is increased by the identified event, controlling (e.g., the operation 1030 of FIG. 10) the PMIC to increase a voltage of the power signal. The method may include, in response to identifying that a current for driving the component is decreased by the identified event, controlling (e.g., the operation 1040 of FIG. 10) the PMIC to decrease the voltage of the power signal.

For example, the controlling the PMIC to increase the voltage of the power signal may include controlling a regulating circuit connected to the component or the component in the state corresponding to the event at a first timing. The method may include controlling, at a second timing after the first timing, the PMIC to increase the voltage of the power signal.

For example, the method may include, based on a current for driving the component to be increased or be decreased by the event, identifying a first voltage to be used by a regulating circuit corresponding to the component to drive the component in the state. The method may include identifying a maximum voltage among the first voltage and second voltages to be used by other regulating circuits different from the regulating circuit. The method may include, based on a voltage changed by the maximum voltage and a path resistance between the PMIC and the plurality of regulating circuits, determining the voltage of the power signal.

For example, the controlling the PMIC to increase the voltage may include, based on the voltage of the power signal being increased by controlling of the PMIC, controlling the regulating circuit connected to the component or the component in the state corresponding to the event.

For example, the method may include providing, to the plurality of regulating circuits which are low-drop out (LDO) regulating circuits, the power signal having a voltage adjusted by controlling of the PMIC.

For example, the identifying may include, based on a state of the component corresponding to the event, identifying a voltage to be used to drive the LDO regulating circuits and a current to be used to drive the component.

For example, the identifying may include identifying the voltage required to drive the LDO regulating circuits and the current to be used to drive the component, from profile information that is associated with the component and is stored in the memory of the electronic device.

For example, the controlling the PMIC may include, based on a serial interface connecting the processor of the electronic device and the PMIC, transmitting a control signal to increase or decrease the voltage of the power signal to the PMIC. The serial interface may be associated with at least one selected from an inter-integrated circuit (I2C), a system power management interface (SPMI), a serial peripheral interface (SPI), or a mobile industry processor interface (MIPI).

An electronic device according to an embodiment as described above may include a power management integrated circuit (PMIC), a plurality of regulating circuits which receives a power signal from the PMIC through a signal path extended from the PMIC, and a processor. The processor may be configured to identify, based on an event for adjusting a state of a component connected to a first regulating circuit among the plurality of regulating circuits, a first input current and a first input voltage of the first regulating circuit modified by the component switched be in to the state. The processor may be configured to identify a maximum voltage from the first input voltage and second input voltages of, among the plurality of regulating circuits, enabled second regulating circuits different from the first regulating circuit. The processor may be configured to control the PMIC, to adjust a voltage of the power signal in response to the event, based on the maximum voltage, the first input current, second input currents of the second regulating circuits and a path resistance of the signal path.

For example, the processor may be configured to adjust the voltage of the power signal to a combination of the maximum voltage and a voltage decreased in the signal path by the path resistance by controlling the PMIC.

For example, the processor may be configured to obtain magnitude of the voltage decreased in the signal path based on a multiplication of a sum of the first input current and the second input currents and the path resistance.

For example, the processor may be configured to transmit a control signal to adjust the voltage of the power signal through a system power management interface (SPMI) connecting the processor and the PMIC to the PMIC.

For example, the power signal may be a first power signal. The PMIC may include a main-regulating circuit to generate a second power signal to drive the processor from a battery of the electronic device. The PMIC may include a sub-regulating circuit to generate the first power signal. The PMIC may include a controller, which is connected to the processor through the SPMI, to control the sub-regulating circuit based on the control signal.

A method of an electronic device according to an embodiment as described above may include identifying, based on an event for adjusting a state of a component connected to a first regulating circuit among a plurality of regulating circuits of the electronic device, a first input current and a first input voltage of the first regulating circuit modified by the component switched be in to the state. The plurality of regulating circuits may receive a power signal from a power management integrated circuit (PMIC) through a signal path extended from the PMIC of the electronic device. The method may include identifying a maximum voltage from the first input voltage and second input voltages of, among the plurality of regulating circuits, enabled second regulating circuits different from the first regulating circuit. The method may include controlling the PMIC, to adjust a voltage of the power signal in response to the event, based on the maximum voltage, the first input current, second input currents of the second regulating circuits and a path resistance of the signal path.

For example, the controlling may include adjusting the voltage of the power signal to a combination of the maximum voltage and a voltage decreased in the signal path by the path resistance by controlling the PMIC.

For example, the controlling may include obtaining magnitude of the voltage decreased in the signal path based on a multiplication of a sum of the first input current and the second input currents and the path resistance.

For example, the controlling may include transmitting a control signal to adjust the voltage of the power signal through a system power management interface (SPMI) connecting the processor and the PMIC to the PMIC.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

No claim element is to be construed under the provisions of 35 U.S.C. § 112, sixth paragraph, unless the element is expressly recited using the phrase “means for” or “means.”

What is claimed is:

1. An electronic device comprising:
a power management integrated circuit (PMIC);
a plurality of regulating circuits which receives a power signal of the PMIC;
memory comprising one or more storage media storing instructions; and
at least one processor comprising processing circuitry, wherein the instructions, when executed by the at least one processor individually and/or collectively, cause the electronic device to:
identify an event for adjusting a driving state of a component connected to one of the plurality of regulating circuits;
in response to identifying that a current for driving the component is increased by the event, control the PMIC to increase a voltage of the power signal; and
in response to identifying that a current for driving the component is decreased by the event, control the PMIC to decrease the voltage of the power signal.

2. The electronic device of claim 1, wherein the instructions, when executed by the at least one processor individually and/or collectively, cause the electronic device to:
in response to identifying that the current for driving the component is decreased by the event, control the component in the state corresponding to the event or a regulating circuit connected to the component at a first timing; and
control, at a second timing after the first timing, the PMIC to increase the voltage of the power signal.

3. The electronic device of claim 1, wherein the instructions, when executed by the at least one processor individually and/or collectively, cause the electronic device to:
based on a current for driving the component to be increased or be decreased by the event, identify a first voltage to be used by a regulating circuit corresponding to the component to drive the component in the state;
identify a maximum voltage among the first voltage and second voltages to be used by other regulating circuits different from the regulating circuit; and
based on a voltage changed by the maximum voltage and a path resistance between the PMIC and the plurality of regulating circuits, determine the voltage of the power signal.

4. The electronic device of claim 1, wherein the instructions, when executed by the at least one processor individually and/or collectively, cause the electronic device to:
based on the voltage of the power signal being increased by controlling of the PMIC while the current for driving the component is increased by the event, control the component in the state corresponding to the event or a regulating circuit connected to the component.

5. The electronic device of claim 1, wherein a regulating circuit corresponding to the component is configured to,
obtain, based on a low-drop out (LDO) from the power signal of a first voltage, a power signal of a second voltage smaller than the first voltage which is to be used to drive the component.

6. The electronic device of claim 5, wherein the instructions, when executed by the at least one processor individually and/or collectively, cause the electronic device to:
based on a state of the component corresponding to the event, identify the second voltage and a current to be used to drive the component.

7. The electronic device of claim 6, further comprising memory,
wherein the instructions, when executed by the at least one processor individually and/or collectively, cause the electronic device to:
identify the second voltage and the current to be used to drive the component in the state, from profile information which is associated with the component and is stored in the memory.

8. The electronic device of claim 1, wherein the instructions, when executed by the at least one processor individually and/or collectively, cause the electronic device to:
based on a serial interface connecting the processor and the PMIC, transmit a control signal to increase or decrease the voltage of the power signal to the PMIC, and
wherein the serial interface is associated with at least one selected from an inter-integrated circuit (I2C), a system power management interface (SPMI), a serial peripheral interface (SPI), or a mobile industry processor interface (MIPI).

9. The electronic device of claim 8, wherein the power signal is a first power signal,
wherein the PMIC comprise:
a main-regulating circuit to generate a second power signal to drive the processor from a battery of the electronic device;
a sub-regulating circuit to generate the first power signal; and
a controller, which is connected to the processor through the SPMI, to control the sub-regulating circuit based on the control signal.

10. The electronic device of claim 9, wherein the controller is configured to,
adjust a voltage of the sub-regulating circuit based on a parameter inputted to a register based on the control signal.

11. A method of an electronic device, the method comprising:
identifying an event for adjusting a driving state of a component connected to one of a plurality of regulating circuits of the electronic device which receives a power signal of a power management integrated circuit (PMIC) of the electronic device;
in response to identifying that a current for driving the component is increased by the event, controlling the PMIC to increase a voltage of the power signal; and
in response to identifying that a current for driving the component is decreased by the event, controlling the PMIC to decrease the voltage of the power signal.

12. The method of claim 11, wherein the controlling the PMIC to increase the voltage of the power signal comprising:
controlling a regulating circuit connected to the component or the component in the state corresponding to the event at a first timing; and
controlling, at a second timing after the first timing, the PMIC to increase the voltage of the power signal.

13. The method of claim 11, further comprising:
based on a current for driving the component to be increased or be decreased by the event, identifying a first voltage to be used by a regulating circuit corresponding to the component to drive the component in the state;
identifying a maximum voltage among the first voltage and second voltages to be used by other regulating circuits different from the regulating circuit; and
based on a voltage changed by the maximum voltage and a path resistance between the PMIC and the plurality of regulating circuits, determining the voltage of the power signal.

14. The method of claim 11, wherein the controlling the PMIC to increase the voltage comprising:
based on the voltage of the power signal being increased by controlling of the PMIC, controlling the component in the state corresponding to the event or a regulating circuit connected to the component.

15. The method of claim 11, further comprising:
providing, to the plurality of regulating circuits which are low-drop out (LDO) regulating circuits, the power signal having a voltage adjusted by controlling of the PMIC.

16. The method of claim 15, further comprising:
based on a state of the component corresponding to the event, identifying a second voltage and a current to be used to drive the component.

17. The method of claim 16, wherein the identifying the second voltage comprising:
identifying the second voltage and the current to be used to drive the component in the state, from profile information which is associated with the component and is stored in memory of the electronic device.

18. The method of claim 11, wherein the controlling the PMIC to increase the voltage comprising:
based on a serial interface connecting the processor and the PMIC, transmitting a control signal to increase or decrease the voltage of the power signal to the PMIC,
wherein the serial interface is associated with at least one selected from an inter-integrated circuit (I2C), a system power management interface (SPMI), a serial peripheral interface (SPI), or a mobile industry processor interface (MIPI).

19. The method of claim 11, wherein the power signal is a first power signal,
wherein the PMIC comprises:
a main-regulating circuit to generate a second power signal to drive the processor from a battery of the electronic device;
a sub-regulating circuit to generate the first power signal; and
a controller, which is connected to the processor through the SPMI, to control the sub-regulating circuit based on the control signal.

20. A non-transitory computer readable storage medium storing instructions, when the instructions are executed by an electronic device including a power management integrated circuit (PMIC), and a plurality of regulating circuits which receives a power signal of the PMIC, cause the electronic device to:
identify, based on an event for adjusting a state of a component connected to a first regulating circuit among the plurality of regulating circuits, a first input current and a first input voltage of the first regulating circuit modified by the component switched to be in the state;
identify a maximum voltage from the first input voltage and second input voltages of, among the plurality of regulating circuits, enabled second regulating circuits different from the first regulating circuit; and
control the PMIC, to adjust a voltage of the power signal in response to the event, based on the maximum voltage, the first input current, second input currents of the second regulating circuits and a path resistance of a signal path.
